(19) United States
(12) Patent Application Publication
(10) Pub. No.: US 2005/0131660 A1
(43) Pub. Date: Jun. 16, 2005

(54) Method for content driven image compression

(76) Inventors: Joseph Yadegar, Santa Monica, CA (US); Jacob Yadegar, Santa Monica, CA (US)

Correspondence Address: CISLO & THOMAS, LLP, 233 WILSHIRE BLVD, SUITE 900, SANTA MONICA, CA, 90401-1211, US

(21) Appl. No.: 10/656,067

(22) Filed: Sep. 5, 2003

Related U.S. Application Data
(60) Provisional application No. 60/408,742, filed on Sep. 6, 2002.

(51) Int. Cl. H04N 11/04; H04N 11/02; H04N 7/12; H04B 1/66; G06K 9/46; G06K 9/36; G06F 15/18; G06F 17/10; G06F 7/60

(52) U.S. Cl. 703/2; 382/232; 375/240; 348/384.1

(57) ABSTRACT

A method with related structures and computational components and modules for modeling data, particularly audio and video signals. The modeling method can be applied to different solutions such as 2-dimensional image/video compression, 3-dimensional image/video compression, 2-dimensional image/video understanding, knowledge discovery and mining, 3-dimensional image/video understanding, knowledge discovery and mining, pattern recognition, object meshing/tessellation, audio compression, audio understanding, etc. Data representing audio or video signals is subject to filtration and modeling by a first filter that tessellates data having a lower dynamic range. A second filter then further tessellates, if needed, and analyzes and models the remaining parts of data, not analyzable by first filter, having a higher dynamic range. A third filter collects in a generally lossless manner the overhead or residual data not modeled by the first and second filters. A variety of techniques including computational geometry, artificial intelligence, machine learning and data mining may be used to better achieve modeling in the first and second filters.

### CROSS-REFERENCES TO RELATED APPLICATIONS

This patent application is related to and claims priority from United States Provisional Patent Application Ser. No. 60/408,742 filed Sep. 6, 2002 entitled Method for Content Driven Data Compression which application is incorporated herein by this reference thereto.

### BACKGROUND OF THE INVENTION

1. Field of the Invention

This invention relates to methods and devices for compressing data, such as image or voice data.

2. Description of the Related Art

Communicating data over network channels or having them stored in repository devices could be an expensive practice—the greater the amount of data, the more expensive its transmission or storage. To alleviate costs, scientists founded compression science—a rigorous discipline within science, mathematics and engineering.

In its most general sense, data compression attempts to reduce the size of the raw data by changing it into a compressed form so that it consumes less storage or transmits across channels more efficiently with less costs—the greater the compression ratio, the higher the savings. Compression scientists strive to come up with more effective compression methods to increase Compression Ratio, defined as CR=R/C, where R and C are considered the quantities of raw data and compressed data, respectively.

A technology that compresses data is made up of a compressor and a decompressor. The compressor component compresses the data at the encoder (transmitting) end and the decompressor component decompresses the compressed data at the decoder (receiving) end.

Data compression manifests itself in three distinct forms: text, voice and image, each with its specific compression requirements, methods and techniques. In addition, compression may be formed in two different modes: lossless and lossy. In lossless compression methods, no information is lost in compression and decompression processes. The decompressed data at the decoder is identical to the raw data at the encoder. In contrast, lossy compression methods allow for loss of some data in compression process. Consequently the decompressed data at the decoder is nearly the same as the raw data at the encoder but not identical.

Irrespective of whether lossy or lossless, or whether text, voice or image, compression methods have traditionally been accomplished within data-driven paradigm.

Let [symbol] be a system, and let [symbol] and O be the set of all possible inputs and outputs to and from [symbol] respectively. Let i and o be specific elements of [symbol] and O such that [symbol] (i)=o, that is input i into system [symbol] outputs o.

System [symbol] is said to be data-driven, if either:

Prior to run-time application, [symbol] is not trained on any subsets of [symbol] and O to improve output behavior, or
[symbol] (i)=o is immutably true—that is, irrespective of the number of times [symbol] runs with i, the output is always o.

Within the context of a data-driven image compression system, the compression engine performs immutably the same set of actions irrespective of the input image. Such a system is not trained a priori on a subset of images to improve performance in terms of compression ratio or other criteria such as the quality of image output at the decoder (receiving) end. Neither does the system improve compression ratio or output quality with experience—that is with repeated compression/decompression. For a data-driven image compressor, CR and output quality are immutably unchanged. Date-driven compression systems do not take advantage of the various features and relationships existing within segments of an image, or voice profile to improve compression performance.

In sharp contrast, a content-driven (alternatively named as conceptually-driven, concept-drive, concept-based, content-based, context-driven, context-based, pattern-based, pattern-driven or the like) system is smart and intelligent in that it acts differently with respect to each different input. Using the symbols introduced above:

System [symbol] is said to be content-driven, if either:

Prior to run-time application, [symbol] is trained on some subsets of [symbol] and O to improve output behavior, or
[symbol] (i[n+1])≠ [symbol] (i[n])∀ i and n—that is, [symbol] run with any iε [symbol] at time n is not identical to [symbol] run with the same i at time n+1.

Improvement in output behavior is measured in terms of error reduction. Technically, output o[n+1] is said to an improvement over output o[n] if the error introduced by the system [symbol] at time n+1 is less than that at time n, a capability that is absent in data-driven methods.

Within the context of a content-driven image compression system, the compression engine has either been trained on some set of images prior to run-time application or has the capability of self-improving at run-time. That is, the experience of compressing at run-time improves the behavior—the greater the quantity of experience the better the system. The compression concept of the present invention introduces a new approach to image or voice data compression consisting of both data-driven and content-driven paradigms.

### SUMMARY OF THE INVENTION

The image compression methodology of the present invention is a combination of content-driven and data-driven concepts deployable either as a system trainable prior to run-time use, or self-improving and experience-accumulating at run-time. In part, this invention employs the concept of compressing image or voice data using its content's features, characteristics, or in general, taking advantage of the relationships existing between segments within the image or voice profile. This invention is also applicable to fields such as surface meshing and modeling, and image understanding.

When applied to images, the compression technology concept of the present invention is composed of three filters. Filter 1, referred to as Linear Adaptive Filter, employs 3-dimensional surface tessellation (referred to as 3D-Tessellation) to capture and compress the regions of the image wherein the dynamic range of energy values is low to medium.

The remaining regions of the image, not captured by the Linear Adaptive Filter, contain highly dynamic energy values. These regions are primarily where sharp rises and falls in energy values take place. Instances of such rises and falls would be: edges, wedges, strips, crosses, etc. These regions are processed by Filter 2 in the compression system described in this document and is referred to as Non-Linear Adaptive Filter. The Non-Linear Adaptive Filter is complex and is composed of a hierarchy of integrated learning mechanisms such as AI techniques, machine learning, knowledge discovery and mining. The learning mechanisms used in the compression technology described in this document, are trained prior to run-time application, although they may also be implemented as self-improving and experience-accumulating at run-time.

The remaining regions of the image, not captured by the Non-Linear Adaptive Filter, are highly erratic, noise-like, minuscule in size, and sporadic across the image. A lossless coding technique is employed to garner further compression from these residual energies. This will be Filter 3—and the last filter—in the compression system.

In one embodiment of the present system, a method for modeling data using adaptive pattern-driven filters applies an algorithm to data to be modeled based on computational geometry, artificial intelligence, machine learning, and/or data mining so that the data is modeled to enable better manipulation of the data.

In another embodiment, a method for compressing data provides a linear adaptive filter adapted to receive data and compress the data that have low to medium energy dynamic range, provides a non-linear adaptive filter adapted to receive the data and compress the data that have medium to high energy dynamic range, and provides a lossless filter adapted to receive the data and compress the data not compressed by the linear adaptive filter and the non-linear adaptive filter, so that data is compressed for purposes of reducing its overall size.

In another embodiment, A method for modeling an image for compression obtains an image and performs computational geometry to the image as well as applying machine learning to decompose the image such that the image is represented in a data form having a reduced size.

In yet another embodiment, a method for modeling an image for compression formulates a data structure by using a methodology that may include computational geometry, artificial intelligence, machine learning, data mining, and pattern recognition techniques in order to create a decomposition tree based on the data structure.

In another embodiment, a data structure for use in conjunction with file compression is disclosed having binary tree bits, an energy row, a heuristic row, and a residual energy entry.

### BRIEF DESCRIPTION OF THE DRAWINGS

FIG. 1 illustrates a linearization procedure.

FIG. 2 shows six stages of Peano-Cezaro binary decomposition of a rectangular domain.

FIG. 3 illustrates two stages of Sierpinski Quaternary Decomposition of an Equilateral Triangle.

FIG. 4 depicts two stages of ternary decomposition.

FIG. 5 depicts two stages of hex-nary decomposition.

FIG. 6 depicts Projected Domain D(X,Y) circumscribed by a rectangular hull.

FIG. 7 depicts Stage 2 and Stage 3 3-dimensional tessellation of a hypothetical image profile in (Energy, x, y) space based on Peano-Cezaro decomposition scheme.

FIG. 8 depicts samples of canonical primitive image patterns.

FIG. 9 depicts samples of parametric primitive patterns.

FIG. 10 illustrates four stages of Peano-Cezaro Binary Decomposition of a Rectangular Domain, showing directions of tile sweeps and tile inheritance code sequences.

FIG. 11 is stage 1 of 3D-Tessellation Procedure.

FIG. 12 is a binary tree representation of Peano-Cezaro decomposition.

FIG. 13 shows eight types of tiles divided into two groups.

FIG. 14 is decomposition grammar for all eight types of tiles with bit assignments.

FIG. 15 is a cluster of side and vertex adjacent tiles.

FIG. 16 is a fragment of a binary decomposition tree.

FIG. 17 depicts tile state transition in Filter 2 processing.

FIG. 18 illustrates four tile structures with right-angles side sizes 9 and 5.

FIG. 19 is a partition of energy values using a classifier.

FIG. 20 is a learning unit.

FIG. 21 is a miniscule tile structure with one blank site.

FIG. 22 is a diagram showing the duality of content vs. context.

FIG. 23 is a diagrammatic roadmap for developing the various generations of intelligent codec.

FIG. 24 depicts decomposition of image frame into binary triangular tiles and their projection onto the manifold.

FIG. 25 shows the eight possible decomposition directionalities arising from decomposition.

FIG. 26 is a learning unit.

FIG. 27 is a diagram illustrating a few primitive patterns.

FIG. 28 portrays a tile affecting the priorities of neighboring tiles for a simple hypothetical scenario.

FIG. 29 illustrates a partition where each set has a very small dynamic range.

FIG. 30 illustrates an image and its reconstructions without and with deepest rollup and the estimated generic as well as class based codec estimation performance.

FIGS. 31-34 illustrate images having different characteristics possibly susceptible to class-based analysis.

FIG. 35 shows regular quaternary quadrilateral and triangular decompositions.

FIG. 36 illustrates the computation of the inheritance labels.

FIG. 37 is an illustration of eight tile types similar to that of FIG. 13.

FIG. 38 illustrates a tree representation of triangular decomposition.

FIG. 39 illustrates a standard unit-cube tetrahedral cover.

FIG. 40 illustrates a decomposition of a tetrahedron by recursive bisection.

FIG. 41 illustrates an overview of the mesh extraction procedure.

FIG. 42 illustrates meshing at three different scales.

FIG. 43 depicts the second stage of image decomposition into binary triangular tiles.

FIG. 44 is a learning unit.

FIG. 45 portrays a tile affecting the priorities of neighboring tiles for a simple hypothetical scenario.

### DESCRIPTION OF THE PREFERRED EMBODIMIENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

The present system provides a generic 2-dimensional modeler and coder, a class-based 2-dimensional modeler and coder, and a 3-dimensional modeler and coder. Description of these aspects of the present system are set forth sequentially below, beginning with the generic 2-dimensional modeler and coder.

Generic 2-Dimensional Modeler and Coder

The following example refers to an image compression embodiment, although it is equally applicable to voice profiles. The image compression concept of the present invention is based on a programmable device that employs three filters, which include a tessellation procedure, hereafter referred to as 3D-Tessellation, a content-driven procedure hereafter referred to as Content-Driven-Compression, and a lossless statistical coding technique.

A first filter, referred to as Filter 1, implements a triangular decomposition of 2-dimensional surfaces in 3-dimensional space which may be based on: Peano-Cezaro decomposition, Sierpiski decomposition, Ternary triangular decomposition, Hex-nary triangular decomposition, or any other triangular decomposition. Each of these decomposition methods enable planar approximation of 2-dimensional surfaces in 3-dimensional space.

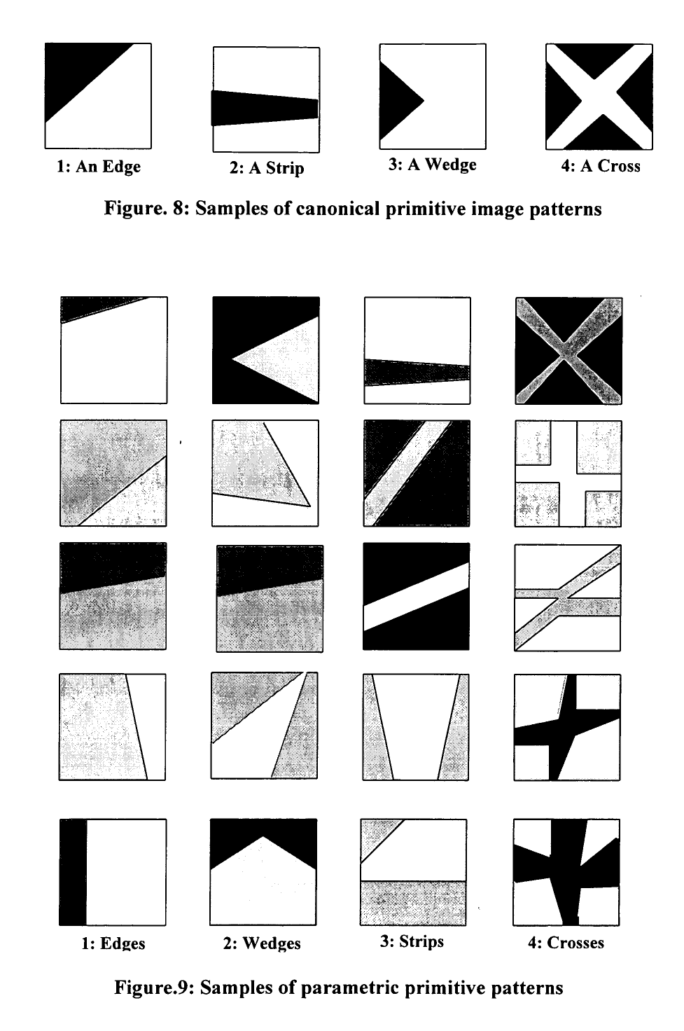

A second filter, referred to as Filter 2, performs the tasks of extracting content and features from an object within an image or voice profile for the purpose of compressing the image or voice data. Primitive image patterns, shown in FIG. 8 in their canonical forms, and in FIG. 9 in their parametric forms, can be used as input to learning mechanisms, such as decision trees and neural nets, to have them trained to model these image or voice patterns. Input to these learning mechanisms is a sufficient set of extracted features from primitive image patterns as shown in FIGS. 8 and 9. Outputs of the learning mechanisms are energy intensity values that approximate objective intensity energy values within the spatial periphery of image primitive patterns.

A third filter, referred to as Filter 3, losslessly compresses the residual data from the other two filters, as well as remaining miniscule and sporadic regions in the image not processed by the first two filters.

In Filter 2, application of learning mechanisms as described in this document to image compression is referred to as content-driven. Content-driven image compression significantly improves compression performance in terms of obtaining substantially higher compression ratios than data-driven image compression methods, more enhanced image reconstruction quality than data-driven image compression methods and more efficient compression/decompression process than data-driven image compression methods.

Substantial improvements are achievable because many tiles in the image containing complex primitive image patterns as shown in FIGS. 8 and 9 find highly accurate models by the application of learning mechanisms, which would otherwise have to be broken into smaller tiles had it been a purely data-driven image compression system used to model the very same tiles. A combination of filters results in a unique image compression/decompression (codec) system based on data-driven, content-driven and statistical methods,

The codec is composed of Filter1, Filter2 and Filter3, where Filter 1 is a combination of regression and pattern prediction codec based on tessellation of 2-dimensional surfaces in 3-dimensional spaces described previously, where Filter 1 tessellates the image according to breadth-first, depth-first, best-first, any combination of these, or any other strategy that tessellates the image in an acceptable manner.

Filter 2 is a content-driven codec based on a non-planar modeling of 2-dimensional surfaces in 3-dimensional spaces described previously. Filter 2 is a hierarchy of learning mechanisms that models 2-dimensional tessellations of the image using primitive image patterns shown in FIG. 9 as input. For this exemplary embodiment, Filter 2 employs the best-first strategy.

Best-first tessellation of the image in Filter 2 can be implemented using a hash-function data-structure based on prioritization of tessellations or tiles for modeling. The prioritization in turn is based on the available information within and surrounding a tile. The higher the available information, the higher the prioritization of the tile for processing in Filter 2.

Filter 3 is a statistical coding method described previously.

The overall codec has significantly higher performance capabilities than purely data-driven compression methods. This is because that global compression ratios obtained using these filters are multiple products of the component compression ratios. This results in considerably higher compression ratios than purely data-driven compression methods, and the quality of image reconstruction is more enhanced than the purely data-driven compression methods based on outstanding fault tolerance of learning mechanisms. The codec is more efficient than the purely data-driven methods as many mid-size tiles containing complex primitive image patterns get terminated by Filter 2, thus drastically curtailing computational time to break those tiles further and have them tested for termination as is done by data-driven compression methods.

The codec is also customizable. Because Filter 2 is a hierarchy of learning units that are trained on primitive image patterns, the codec can be uniquely trained on a specific class of images which yields class-based codecs arising from class-based analysis. This specialization results in even higher performance capabilities than a generic codec trained on a hybrid of image classes. This specialization feature is an important advantage of this technology which is not applicable to the purely data-driven methods.

The codec has considerable tolerance to fault or insufficiency of raw data due to immense graceful degradation of learning mechanisms such as neural nets and decision trees, which can cope with lack of data, conflicting data and data in error.

The worst-case time complexity of the codec is n log n, n being the number of pixels in the image. The average time complexity of the codec is much less than n log n. The codec has an adjustable switch at the encoder side that controls the image reconstruction quality, and zoom-in capability to generate high quality reconstruction of any image segment, leaving the background less faithful.

The codec has the advantage that the larger the image size the greater the compression ratio. This is based on a theorem that proves that the rate of growth of compression ratio with respect to cumulative overhead needed to reconstruct the image is at worst linear and at best exponential.

Returning to the topic of tessellating a surface in 3-dimensional space, in general, tessellating a surface in some n-dimensional space means to approximate the surface in terms of a set of adjacent surface segments in a (n−1)-dimensional space.

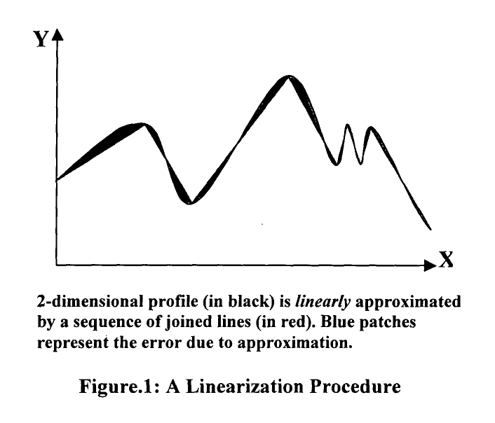

An example is to tessellate a 2-dimensional profile in terms of a set of line segments as shown in FIG. 1.

Another example would be to approximate a circle by a regular polygon, an ellipse by a semi-regular polygon, a sphere by a regular 3-dimensional polyhedron and an ellipsoid by a semi-regular 3-dimensional polyhedron. Naturally, this tessellation concept can be extended to higher dimensions.

The shaded region in FIG. 1 entrapped by the objective profile and the tessellation approximation is the error introduced by virtue of the tessellation approximation. In general, the closer the tessellation approximation to the objective surface the smaller the error and thus the more accurate the tessellation approximation. In many tessellation cases the approximation collapses on the objective surface, as tessellation gets infinitely fine, hence making error tend to zero. Such tessellation methods are referred to as faithful tessellations, otherwise they are called non-faithful.

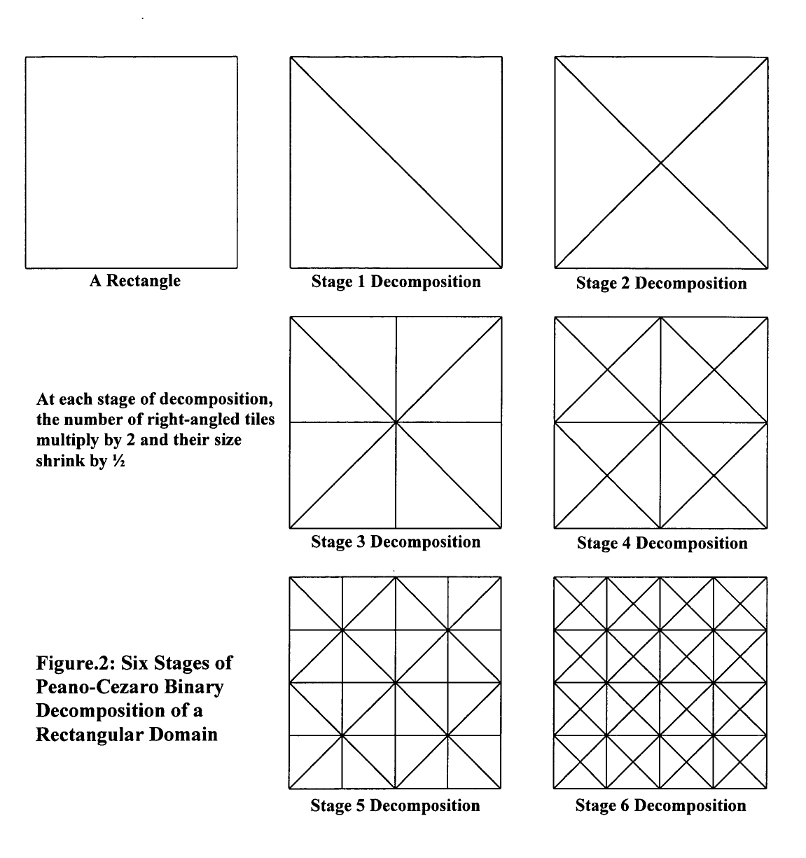

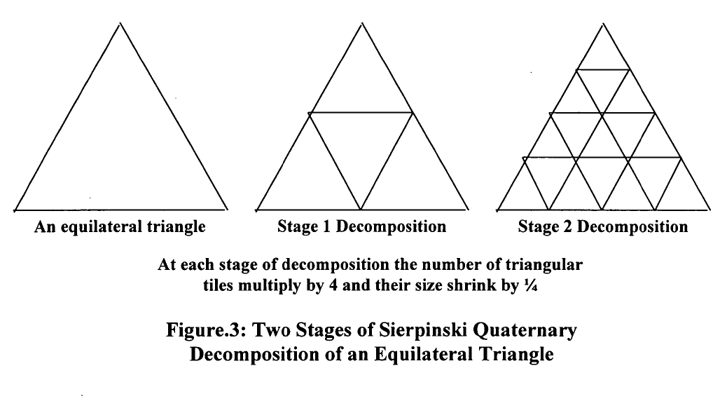

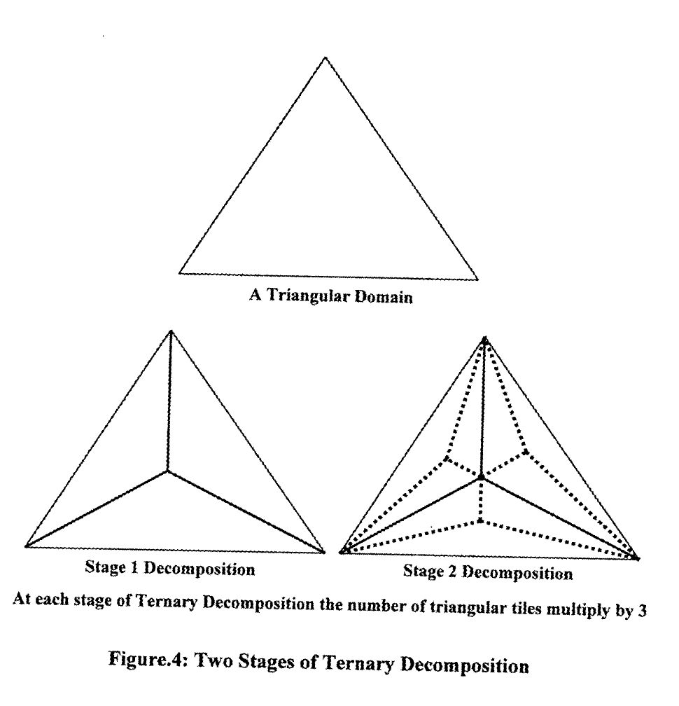

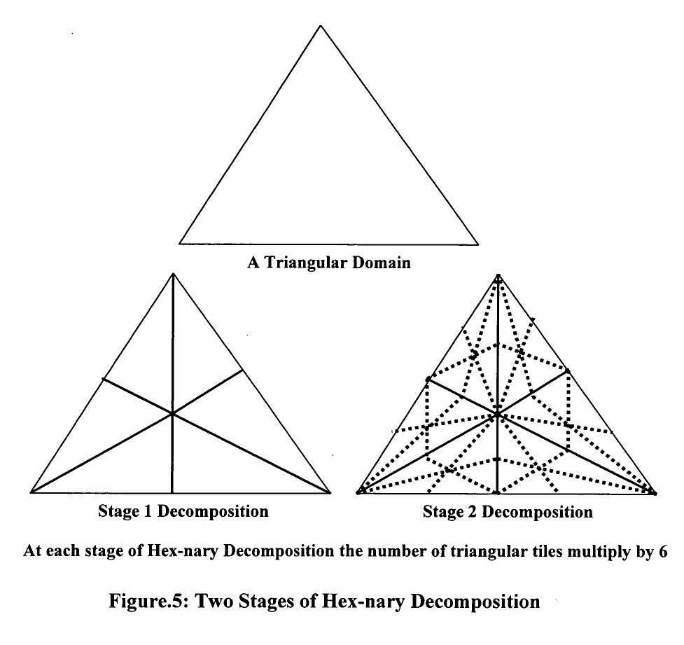

The technology of the present invention includes a general triangular tessellation procedure for surfaces in 3-dimensional space. The tessellation procedure is adaptable to faithful as well as non-faithful triangular tiles based on any one of the following 2-dimensional tessellation procedures:
Peano-Cezaro binary quadratic decomposition of a rectangular domain, shown in FIG. 2;
Sierpinski quaternary triangular decomposition of an equilateral domain, shown in FIG. 3;
Ternary triangular decomposition of a triangular domain, shown in FIG. 4; or
Other (e.g., hex-nary) triangular decomposition of the plane, shown in FIG. 5. These and other tessellation procedures are extensible to n-dimensional spaces, which can be used as a method of approximating n-dimensional surfaces into a set of adjacent (n−1)-dimensional surface segments.

FIG. 2 shows six stages of Peano-Cezaro binary quadratic triangular decomposition of a rectangular domain into a set of right-angled triangles. These stages can be extended to higher levels indefinitely, where each decomposition level shrinks the triangles by half and multiplies their number by a factor of 2.

Sierpinski quaternary triangular decomposition of an equilateral triangular domain is illustrated in FIG. 3. FIG. 3 shows three stages of tessellating an equilateral triangle into a set of smaller equilateral triangles. These stages can be extended to higher levels indefinitely, where each level shrinks the triangles to ¼ in size and multiples their numbers by a factor of 4. Moreover, the domain of tessellation need not be an equilateral triangle. For instance, it may be any triangle, a parallelogram, a rectangle, or any quadrilateral.

Ternary triangular decomposition of a triangular domain is illustrated in FIG. 4. FIG. 4 shows two stages of tessellating a triangle into a set of smaller triangles. These stages can be extended to higher levels indefinitely, where each level shrinks the triangles and multiplies their numbers by a factor of 3. Other planar decomposition schemes such as hex-nary, shown in FIG. 5, exist and may also be used as the basis for the 3-dimensional tessellation procedure filed for patent in this document.

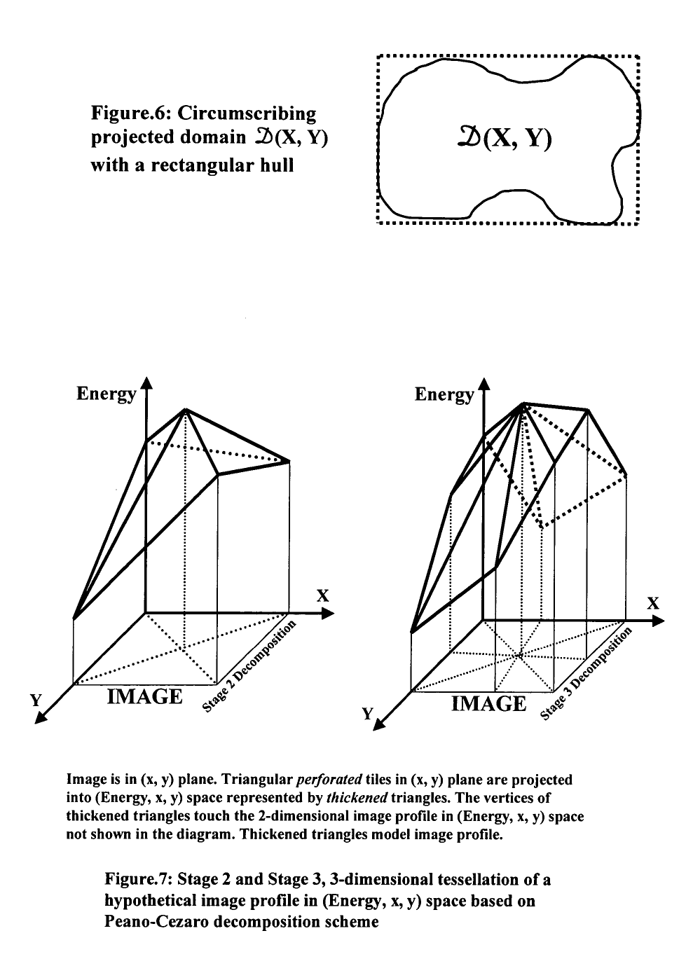

The 3-dimensional procedure of the present invention takes a surface profile in 3-dimensional space and returns a set of adjacent triangles in 3-dimensional space with vertices touching the objective surface or using regression techniques to determine most optimal fit. The generation of these triangles is based on using any one of the planar decomposition scheme discussed above. Specifically, the tessellation procedure in 3-dimensional space is as follows. Assume a surface S (x, y, z) in 3-dimensional space (x, y, z) and let D (x, y) be the orthogonal projection of S (x, y, z) onto (x, y) plane. We assume D (x, y) circumscribed by a rectangle—see FIG. 6 for an example. Without loss of generality, in the algorithm below we identify D (x, y) with the rectangular hull.

3-Dimensional Tessellation Procedure

```
1 - Apply first stage Planar Decomposition to D(x, y)
  // Returns triangular tiles //
2 - Deposit tiles in Queue
3 - While there is a tile in Queue
      Get tile
      // Call it T(x, y) //
      Get orthogonal projection of vertices of T(x, y)
      onto the surface S(x, y, z)
      // Thereby projecting T(x, y) onto a new planar triangle in (x, y, z)
      space, say R(x, y) with its vertices touching S(x, y, z) //
      If | R(x, y) − S(x, y, z) | ≦ Error-Tolerance, ∀ x, y ∈ T(x, y)
      // | R(x, y) − S(x, y, z) | measures the error in R(x, y) − S(x, y, z) //
        Declare R(x, y) and T(x, y) Terminal
        // R(x, y) is an accurate planar approximation of S(x, y, z) //
      Else  // | R(x, y) − S(x, y, z) | > Error-Tolerance,
      for some x, y ∈ T(x, y) //
        Apply Planar Decomposition to T(x, y)
        // Returns triangular tiles //
        Deposit tiles in Queue
4 - Return Terminal tiles
// Terminal tiles represent a close approximation to S(x, y, z) //
```

FIG. 7 illustrates the first two stages of the above procedure using Peano-Cezaro triangular decomposition on a hypothetical 3-dimensional surface. In FIG. 7 R(x, y) is an image in (x, y) plane and S(x, y, z) is the image profile in 3-dimensional space (x, y, z) where z, the third dimension, is the energy intensity value at coordinate (x, y) in the image plane. The 3-dimensional tessellation procedure in FIG. 7 can be formulated, not only with respect to Peano-Cezaro decomposition but also, in terms of the other decompositions, such as Sierpinski, described earlier.

Meaningful images, those that make sense to a cognitive and rational agent, contain many primitive patterns that may be advantageously used for compression purposes as shown in FIG. 8. The set of primitive patterns extracted from a large set of images is large. However, this set is radically reducible to a much smaller set of canonical primitive patterns. Each of these canonical patterns is bound to a number of variables whose specific instantiations give an instance of a primitive pattern. These variable parameters are primarily either energy intensity distributions, or geometrical configurations due to borders that delineate regions in a pattern. FIG. 9 depicts a few cases of each of the canonical forms in FIG. 8.

To take an example, FIG. 9(1) shows five orientations of an edge in FIG. 9(1). It also shows different intensity distributions across the pattern. Clearly there are many possibilities that can be configured for an edge. Similar argument applies to a wedge, a strip, a cross, or other canonical primitive patterns. The challenge in front of a content-driven image compression technology is to be able to recognize primitive patterns correctly.

Machine Learning & Knowledge Discovery, a branch of Artificial Intelligence, can be applied to the recognition purpose sought for the content-driven image compression concept of the present invention. Various machine learning techniques, such as neural networks, rule based systems, decision trees, support vector machine, hidden Markov models, independent component analysis, principal component analysis, mixture of Gaussian models, fuzzy logic, genetic algorithms and/or other learning regimes, or combination of them, are good candidates to accomplish the task, at hand. These learning machines can either be trained prior to run-time application using a training sample set of primitive patterns or have them trained on the fly as the compressor attempts to compress images. To generate a model for a primitive pattern within a certain region of image referred to as tile, the learning mechanism is activated by an input set of features extracted from the tile. For a model to be accurate, the extracted features must form a sufficient set of boundary values for the tile sought for modeling.

The content-driven image compression concept filed for patent in this document is proposed below in two different modes. The first mode applies to training the compression system prior to run-time application. The second mode is a self-improving, experience-accumulating procedure trained at run-time. In either procedure, it is assumed that the image is decomposed into a set of Tiles to which the Learning Mechanism may apply. The set of Tiles are stored in a data structure called QUEUE. The procedure calls for Tiles, one at the time, for analysis and examination. If Learning Mechanism is successful in finding an accurate Model for Tile at hand—measured in terms of an Error_Tolerance, it is declared Terminal and computation proceeds to the next Tile in the QUEUE if there is one left. Otherwise, if Model is inaccurate and TileSize is not (MinTileSize) minimal, Tile is decomposed into smaller sub-tiles, which are then deposited in the QUEUE to be treated later. In case Tile is of minimum size and can no longer be decomposed further, it is itself declared Terminal—meaning that the TileEnergy values within its territory are recorded for storage or transmission. Computation ends when QUEUE is exhausted of Tiles at which time Terminal Tiles are returned.

### Content-Driven Image Compression Procedure: Case I: Learning Mechanism Trained Prior to Run-Time

While there is Tile in QUEUE

```
    Get Tile in QUEUE
    Extract Features from Tile
    Input Featues to Learning Mechanism
    // Let Model be the output //
If | TileEnergy − Model | ≦ Error_Tolerance
// TileEnergy − Model | measures error in energy
values in Model compared //
// to corresponding energy values in Tile //
    Declare Tile Terminal
Else  // | TileEnergy − Model | > Error_Tolerance //
    If TileSize > MinTileSize
        Decompose Tile into Tile₁, Tile₂, ..., Tileₙ
        // In binary, ternary, quaternary, etc. decomposition,
        n = 2, 3, 4, etc. //
        Deposit Tile₁, Tile₂, ..., Tileₙ in QUEUE
    Else  // TileSize ≦ MinTileSize //
        Declare Tile Terminal
```

Return Terminal Tiles

### Content-Driven Image Compression Procedure: Case II: Learning Mechanism Trained at Run-Time

While there is Tile in QUEUE

```
Get Tile in QUEUE
Extract Features from Tile
Input Features to Learning Mechanism
// Let Model be the output //
Adjust Learning Mechanism based on error | TileEnergy − Model |
// | TileEnergy − Model | measures error in energy
values in Model compared //
// to corresponding energy values in Tile //
// Adjust iteratively tunes Learning Mechanism to reduce error in Model //
If | TileEnergy − Model | ≦ Error_Tolerance
    Declare Tile Terminal
Else  // | TileEnergy − Model | > Error_Tolerance //
    If TileSize > MinTileSize
        Decompose Tile into Tile₁, Tile₂, ..., Tileₙ
        // In binary, ternary, quaternary, ... decomposition,
        n = 2, 3, 4, ...//
        Deposit Tile₁, Tile₂, ..., Tileₙ in QUEUE
    Else  // TileSize ≦ MinTileSize //
        Declare Tile Terminal
```

Return Terminal Tiles

Below, we present an iterative learning procedure applicable to a range of learning mechanisms including, but not limited to, neural networks. Such a procedure is used to train the learning mechanism before run-time application of the content-driven image compressor.

In this procedure, we assume given a data-structure QUEUE loaded with a sample set of Tiles each representing a primitive pattern discussed earlier. Tiles carry information on extracted Features. It is assumed that the procedure may cycle (CycleNUM) through QUEUE a fixed maximum number of times (MaxCycleNUM). At each cycle, the procedure calls for Tiles in QUEUE, one at the time, stimulates the Learning Mechanism with Features in Tile, and based on the output Model and TileEnergy values, Adjusts the behavior of Learning Mechanism to diminish subsequent error in Model. Tile is then put back in QUEUE and iteration proceeds to next Tile in QUEUE. Training terminates if either the Global_Error obtained at the end of a cycle is less than the Error_Tolerance or iteration through the cycles has reached MaxCycleNUM. The procedure returns the trained Learning Mechanism.

### An Iterative Procedure to Train Learning Mechanism in a Content-Driven Image Compressor

```
While CycleNUM ≦ MaxCycleNUM
  While there is Tile in QUEUE
    Get Tile in QUEUE
    Input Features to Learning Mechanism
    // Let Model be the output //
    Adjust Learning Mechanism based on error | TileEnergy − Model |
    // Adjust tunes Learning Mechanism to reduce error in Model //
    Update Global_Error with | TileEnergy − Model |
    Deposit Tile back in QUEUE
  If Globa_Error ≦ Error_Tolerance
    Break outer loop
```

Return Learning Mechanism

Finally, we present the encoder (transmitting) and decoder (receiving) procedures for the present invention.

At the encoder side, the inputs to the system are the Image and Error_Tolerance. The latter input controls the quality of Image-Reconstruction at the decoder side. Error_Tolerance in this compression system is expressed as energy levels. For instance, an Error_Tolerance of 5 means deflection of maximum 5 energy levels from the true energy value at the picture site where evaluation is made. Error_Tolerance in this compression system is closely related to the error measure Peak signal to noise ratio (PSNR) well established in signal processing. The output from the encoder is a list or array data structure referred to a Data_Row. The data in Data_Row, compressed in lossless form, consists of four segments described below.

The first segment is Binary_Tree_Bits, the second segment is Energy_Row, the third segment is Heuristic_Row, and the fourth segment is Residual_Energy. The Binary_Tree_Bits and Energy_Row data structures are formed as compression traverses Filter 1 and Filter 2. Heuristic_Row is formed in Filter 2 and Residual_Energy stores the remaining erratic energy values that reach Filter 3 after sifting through Filter 1 and Filter 2. Filter 3 which is a lossless coding technique, compresses all four data structures: Binary_Tree_Bits, Energy_Row, Heuristic_Row and Residual_Energy.

At the decoder side, the input is Data_Row and the output is Image-Reconstruction. First, we state the encoder and decoder procedures, then go on to explain the actions therein.

### Image Compression System: Encoder

Initiate Image Decomposition Using 3D-Tessellation

While there is Tile to Model

Get Tile
Get VertexTileEnergies
// Tile is triangular and has three vertices //

| | |
|---|---|
| If TileSize ≧ LowSize | // Filter 1 begins // |

```
// LowSize is a lower bound on Tile size in Filter 1 //
    Apply Planarization approximation to Tile using VertexTileEnergies
    // Planarization approximates the energy values in Tile with TileModel //
    If | Tile − TileModel | ≦ Error_Tolerance // TileModel is accurate //
    // | Tile − TileModel | measures error in TileModel energy values //
        Declare Tile TerminalTile
            Update Binary_Tree_Bits with TerminalTile
        Else  // TileModel is inaccurate //
            Decompose Tile into Sub-Tiles using 3D-Tessellation
            Get ApexTileEnergy in Image  // where Tile splits into Sub-Tiles //
            Update Binary_Tree_Bits with Tile decomposition
            Store ApexTileEnergy in Energy_Row  // if necessary //
```

| | |
|---|---|
| Else-if TileSize ≧ MinSize | // Filter 2 begins // |

```
    // MinSize is a lower bound on Tile size in Filter 2 //
        Extract Primary-Features in Tile
        // Primary-Features are mainly energy values //
        Extract Secondary-Features in Tile
        // Secondary-Features: ergodicity, energy classification, decision tree path, ...
    //
        // Extract is a procedure that gets and/or computes appropriate Tile Features //
        Input VertexTileEnergies, Primary- and Secondary-Features to Learning-
        Hierarchy // Returns TileModel //
        If | Tile − TileModel | ≦ Error_Tolerance // TileModel is accurate //
            Declare Tile TerminalTile
            Update Binary_Tree_Bits with TerminalTile
            Update Heuristic_Row with Primary- and Secondary-Features
        Else  // TileModel is inaccurate //
            Decompose Tile into Sub-Tiles using 3D-Tessellation
            Get ApexTileEnergy in Image  // where Tile splits into Sub-Tiles //
            Update Binary_Tree_Bits with Tile decomposition
            Store ApexTileEnergy in Energy_Row  // if necessary //
    Else // Tile is miniscule. Store Tile's raw energies in Residual_Energy //
        Get TileEnergies from Image  // if any //
        Store TileEnergies in Residual_Energy
```

| | |
|---|---|
| Apply Lossless Compression to: | // Filter 3 begins // |

(Binary_Tree_Bits, Energy_Row, Heuristic_Row and Residual_Energy)
// Returns a compressed data structure called Data_Row //

Return Data_Row

### Image Compression System: Decoder

```
Decompress Data_Row  // Filter 3 begins //
// Returns Binary_Tree_Bits, Energy_Row, Heuristic_Row and Residual_Energy //
While there is a Node in Binary_Tree_Bits to parse
    Get next Binary_Tree_Bits Node
    If Node is TerminalTile
        Get ApexTileEnergy from Energy_Row // if necessary //
        Get VertexTileEnergies from Reconstructed-Image
```

| | |
|---|---|
| If TileSize ≧ LowSize | // Filter 1 begins // |

```
        // LowSize is a lower bound on Tile size in Filter 1 //
            Paint TerminalTile using TileVertexEnergies and Planarization
            scheme
```

| | |
|---|---|
| Else-if TileSize ≧ MinSize | // Filter 2 begins // |

```
            Get Primary- and Secondary-Features from Heuristic_Row
            Input ApexTileEnergy, VertexTileEnergies, Primary- and Secondary-
            Features to Learning-Hierarchy  // Returns TileModel //
    Paint TerminalTile using TileModel
        Else  // Tile is miniscule. Get raw energies from Residual_Energy //
            Get TileEnergies from Residual_Row
            Paint Tile with TileEnergies
    Else  // Binary_Tree_Bits Node in non-terminal //
        Penetrate Binary_Tree_Bits one level deep
```

Return Image-Reconstruction

Each algorithm is discussed below. We begin with the encoder.

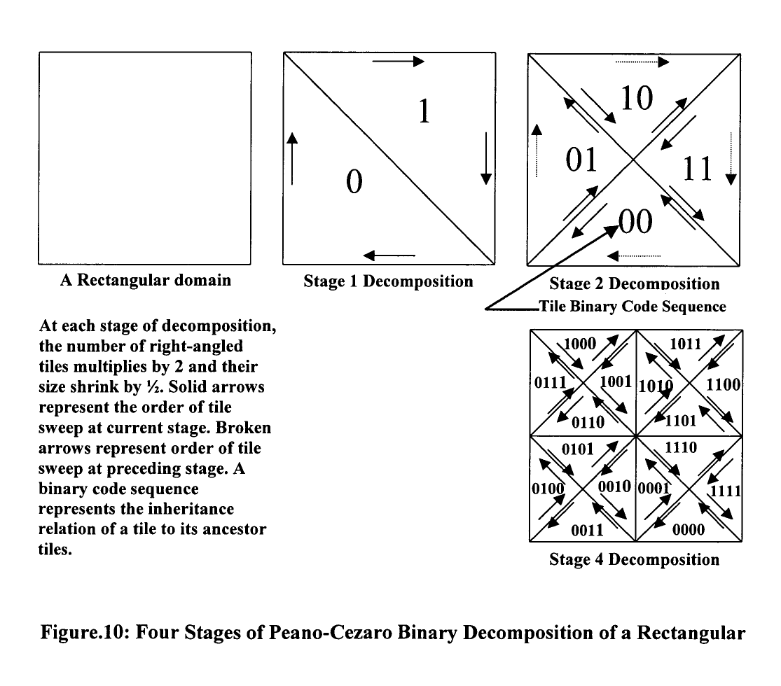

The 3D-Tessellation procedure employed in the image compression system filed for patent in this document can be based on any triangulation procedure such as: Peano-Cezaro binary decomposition, Sierpinski quaternary decomposition, ternary triangular decomposition, hex-nary triangular decomposition, etc. The steps and actions in encoder and decoder procedures are almost everywhere the same. Minor changes to the above algorithms furnish the specifics to each decomposition. For instance, in case of Sierpinski decomposition instead of Binary_Tree_Bits, one requires a Quad_Tree_Bits data structure. Therefore, without loss of generality, we shall consider Peano-Cezaro decomposition in particular. The first four stages of this decomposition are depicted in FIG. 10.

Initially, the image is decomposed into two adjacent right-angled triangles—Stage 1 decomposition in FIG. 10. As decomposition proceeds, each of the right-angled triangles is split at the midpoint of its hypotenuse into two smaller (half size) triangles. The midpoint where the split takes place is referred to as the apex and the image intensity there as ApexTileEnergy. The image intensities at the vertices of a tile are called VertxTileEnergies.

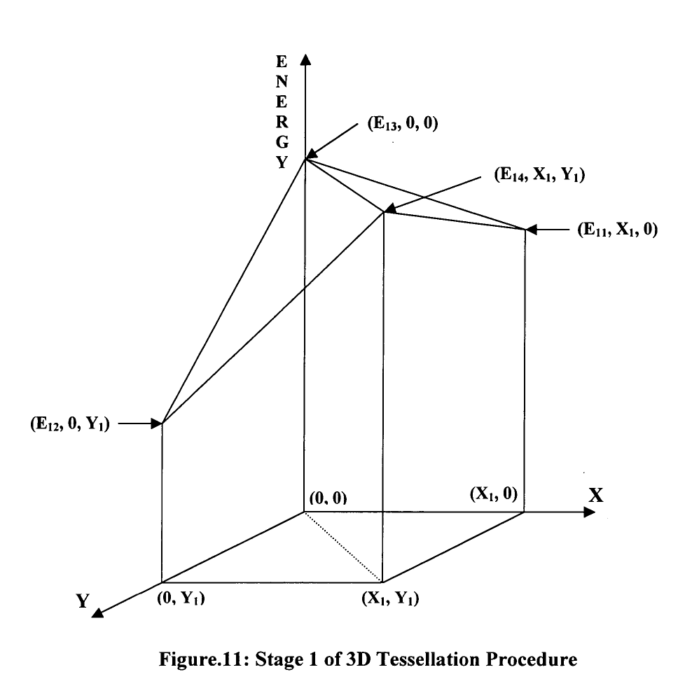

The energy values at pixel sites interpret the image as a 3-dimensional object with the energy as the third dimension, and X- and Y-axis as the dimensions of the flat image. FIG. 11 shows Stage 1 decomposition in FIG. 10 represented in 3-dimensional space with the two adjacent right-angled triangles projected along energy axis. The vertices of these projected triangles touch the image profile in the 3-dimensional space.

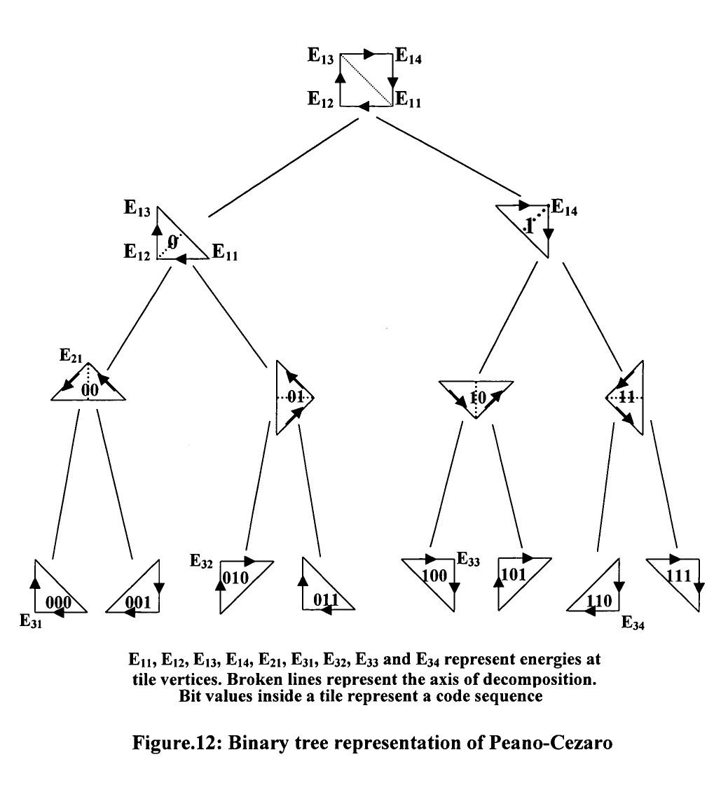

In FIG. 12, E11, E12, E13 and E14 represent the energy intensity values at the four corners of the image, which are stored in Energy_Row data structure.

The Peano-Cezaro decomposition can be represented by a binary tree data structure, which in the encoder and decoder procedures, we refer to as Binary_Tree_Bits. FIG. 12 demonstrates the first three stages in FIG. 10 on this binary tree.

An implicit order of sweep dominates the decomposition procedure. In FIGS. 10 and 12, this order of sweep is shown in two ways—first, by means of arrows running by the right-angled sides and second, by bit values assigned to tiles. As the tree penetrates deeper and tiles get smaller, they inherit bit values of their parent tiles. In this fashion, a tile implicitly carries a code sequence.

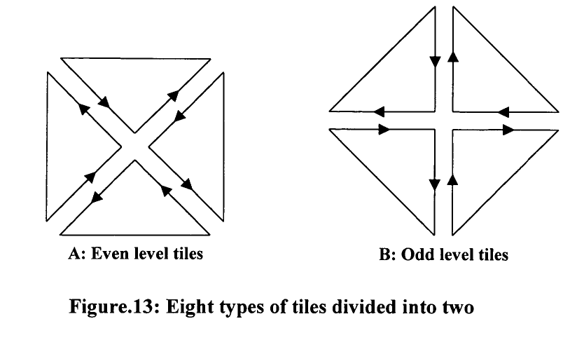

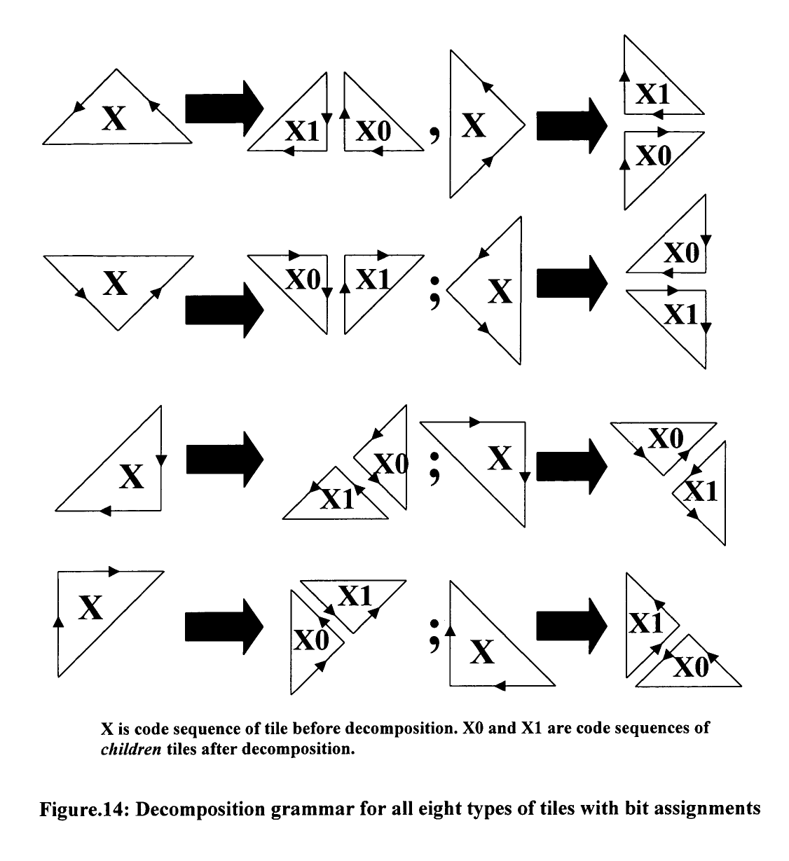

There are eight different types of tiles divided into two groups, each group appearing exclusively at alternative tree levels. These are shown in FIG. 13. FIG. 14 demonstrates the decomposition grammar and the accompanied bit assignment.

Each tree node in FIG. 12 represents a tile. The two branches from each node to lower levels represents the tile decomposition into two sub-tiles and the energy value at the apex, where split takes place, is carried by the first decomposed tile in the order of the sweep. The grammar in FIG. 14 shows how a tile code sequence, X, gets recursively generated. Recursion begins at Stage 1 in FIG. 10 with X=0, 1 (in no particular order), and from there on code sequence expands with tile decomposition. Tile code sequence is required to locate the position of a tile in the image (see for instance, Stage 4 in FIG. 10) as well as getting the neighboring tiles. With code sequence, one is able to know whether a certain tile is running on a side of the image, or located at one of the four vertices of the image, or it osculates a side of the image or it is internal to the image.

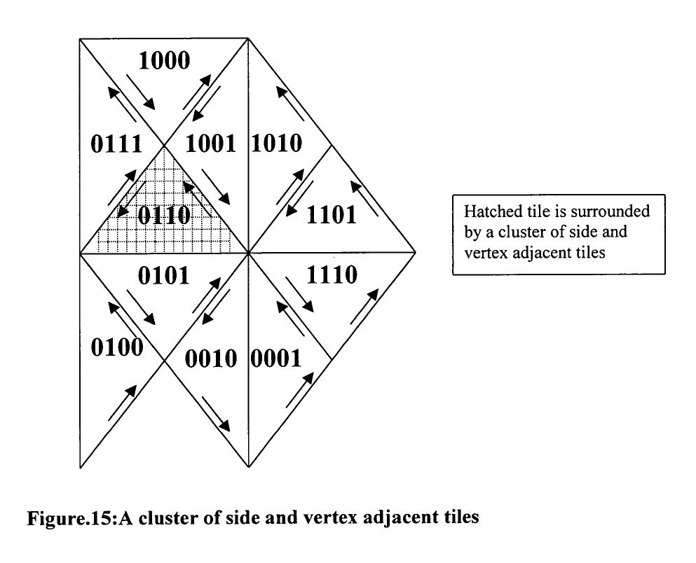

FIG. 15 shows a cluster of neighboring tiles from Stage 4 in FIG. 10. Based on the knowledge of the code sequence of the hatched tile in FIG. 15, one can find code sequences of all the side and vertex adjacent tiles. Code sequences are used heavily in both encoder and decoder programs to examine the neighborhood of a tile. As tiles are decomposed, they are deposited in a binary tree data structure (Binary_Tree_Bits) for examination. Initially, Binary_Tree_Bits gets loaded with two tiles from Stage 1 in FIG. 10. The while loop in the encoder algorithm calls for a Tile in Binary_Tree_Bits—one at the time. Tile is subsequently examined in the following form. It is first checked for size and if sufficiently large (TileSize≧LowSize), it passes through Filter 1 with the hope of finding an accurate model for it. Using the well-known theorem from solid geometry that three points in 3-dimensional space uniquely define a plane, Filter 1 starts by generating a planar approximation model (called TileModel) for Tile given its three vertex energies. The planar approximation model can be achieved by a variety of computational methods, such as: different ways of interpolation and/or more sophisticated AI-based regression methods and/or mathematical optimization methods such as linear programming and/or non-linear programming. This planar TileModel is then compared with Tile to see if the corresponding energy values therein are close to each other (based on an Error-Tolerance). If so, TileModel replaces Tile and it is declared TerminalTile. If TileModel is not a close approximation, Tile is decomposed into two sub-tiles, which means Binary_Tree_Bits is expanded by two new branches at the node where Tile is represented. ApexTileEnergy at the apex where decomposition split takes place is stored in Energy_Row if found necessary. The link in Binary_Tree_Bits leading to the node that represents Tile is coded 1 if it is a TerminalTile otherwise it is coded 0. Binary_Tree_Bits is simply a sequence of mixed 1's and 0's. A 1 implies a terminal tile and a 0 implies decomposing the tile further. The order of 0 and 1 can be interchanged. Indeed, there are a number of other ways to code the Binary_Tree_Bits. For example, an 0 can represent a Terminal Tile and a 1 an intermediate node.

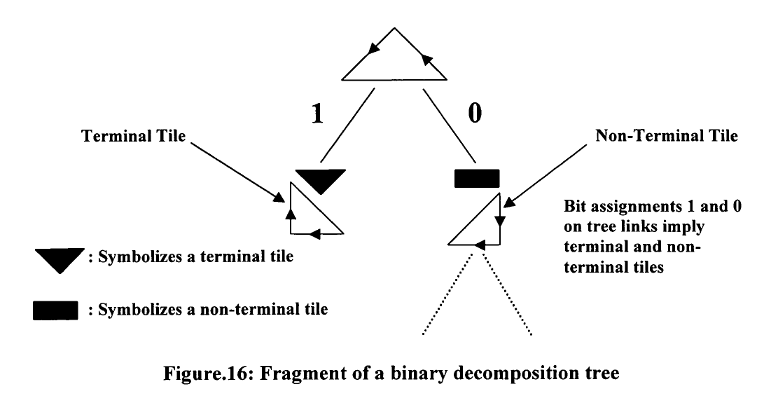

FIG. 16 shows a portion of Binary_Tree_Bits illustrating the meaning of 1's and 0's and their equivalence to terminal and non-terminal tiles.

If Tile size is mid-range (LowSize>TileSize≧MinSize), it ignores Filter 1 but passes through Filter 2 for modeling. For Filter 2, tiles are stored in a complex data structure based on a priority hash function. The priority of a tile to be processed by Filter 2 depends on the available (local) information that may correctly determine an accurate model for it—the greater the quantity of this available information the higher the chance of finding an accurate model to and hence the higher should be its priority to be modeled. Therefore, the priority hash function organizes and stores tiles according to their priorities—those with higher priorities stay ahead to be processed first. Once a model generated by Filter 2 successfully replaces its originator tile, it affects the priority values of its neighboring tiles. FIG. 17 illustrates this point for one particular scenario.

The state transition in FIG. 17 needs explanation. Given state (I), the to-be-modeled tile N1 goes in first for modeling for, it has two neighboring modeled tiles (T1, T2). In comparison, the to-be-modeled-tile N2 has only one neighboring modeled tile (T2). Hence, the local available information for tile N1 is greater than the available information for tile N2 and so it has greater chance of receiving an accurate model than N2. Consequently, N2 follows N1 in hash data structure.

State (II) shows only N2 for modeling. Note that in state (II) the priority value of N2 increases in comparison to its priority in state (I) since it has now more available information from its surrounding terminal tiles (T2, T3). Finally, in State (III) all tiles are declared terminal.

FIG. 17 and the above discussion reveal that the organization of the hash data structure where Filter 2 tiles are stored is highly dynamic. With each modeling step the priority values of neighboring tiles increase, thus causing them jump ahead in the hash data structure and hence, getting them closer to modeling process.

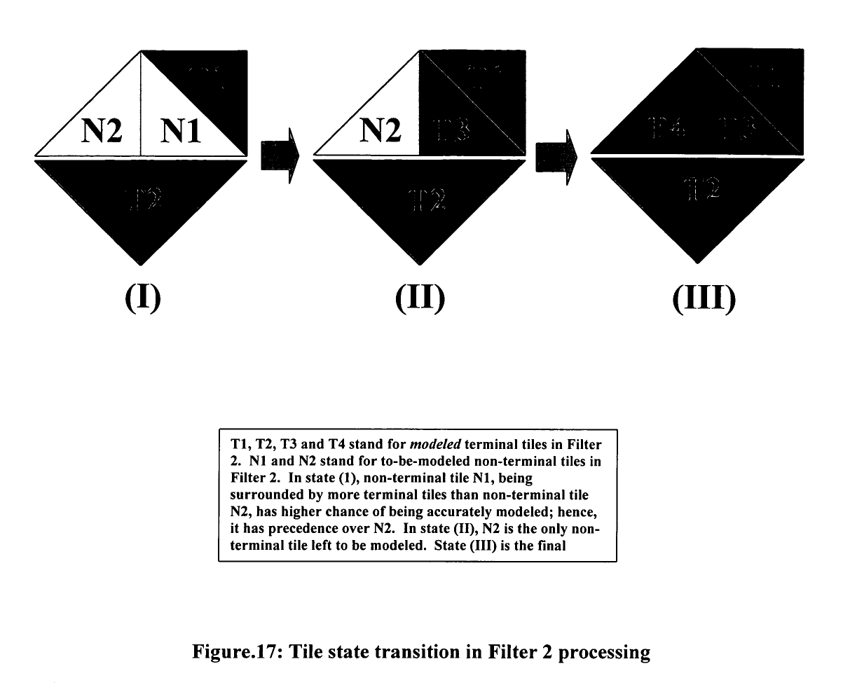

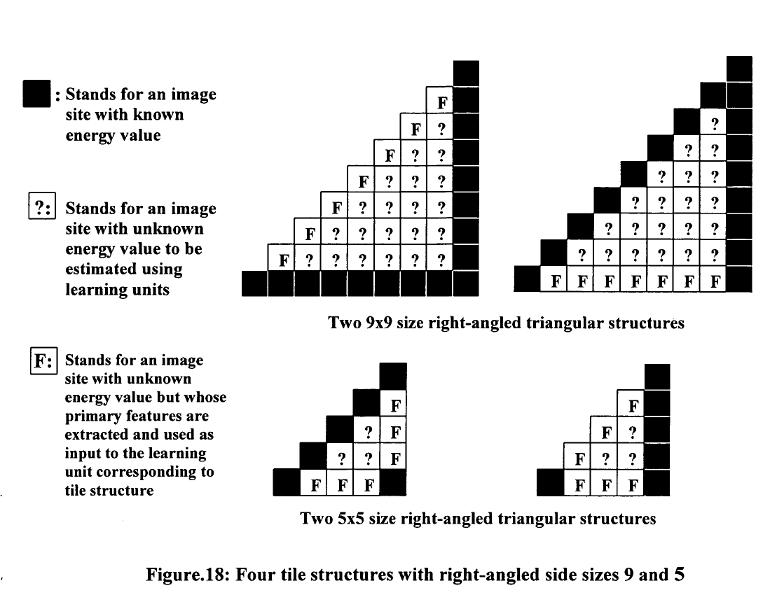

Models generated by Filter 2 are non-planar as they are outputs of non-linear learning mechanisms such as neural networks. The structure of Filter 2 is hierarchical and layered. The number of layers in this learning hierarchy is equal to the number of levels in Binary_Tree_Bits under the control of Filter 2; that is, from the level where Filter 2 begins to the level where it ends, namely (LowSize−MinSize). Each layer in learning hierarchy corresponds to a level in Binary_Tree_Bits where Filter 2 applies. Each layer is composed of a number of learning units each corresponding to a specific tile size and structure. A learning unit can also model various tile sizes and structures, such model is termed a general purpose learning unit. FIG. 18 shows four instances of such tile structures with right-angled side sizes of 5 and 9 pixels.

A learning unit in the learning hierarchy integrates a number of learning mechanisms such as a classifier, a numeric decision tree, a layered neural network, neural networks, support vector machine, hidden Markov models, independent component analysis, principal component analysis, mixture of Gaussian models, genetic algorithms, fuzzy logic, and/or other learning regimes, or combination of them. For example, the classifier takes the available energy values on the borders of Tile in addition to some minimum required features of the unavailable border energies in order to partition the border energies into homologous sets. The features so obtained are referred in the encoder and decoder algorithms as “Primary-Features.”

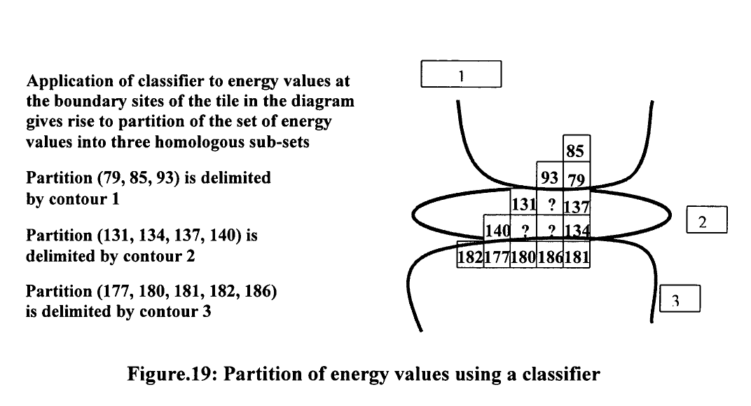

FIG. 19 shows a particular 5×5 size tile structure with energy values on the border sites all known. The classifier corresponding to this structure partitions the sites around the border into three homologous partitions: (79, 85, 93), (131, 134, 137, 140) and (177, 180, 181, 182, 186). Notice that the dynamic range of energy values in each of the three sets is low. The job of the classifier is to partition the border energies (and Primary-Features) such that the resulting partition sets give rise to minimum dynamic ranges. A fuzzy based objective function within the classifier component precisely achieves this goal.

In general each tile structure falls into one of several (possibly many) classes and the classifier's objective is to take the energy values and Primary-Features around the border as input and in return output the class number that uniquely corresponds to a partition. This class number is one of the Secondary-Features.

Next in a learning unit is, for example, a numeric decision tree. The inputs to the decision tree are: known border energy values, and Primary- and Secondary-Features. A decision tree is a learning mechanism that is trained on many samples before use at run-time application. Various measures do exist that form the backbone of training algorithms for decision trees. Information Gain and Category Utility Function are two such measures.

When training is complete, the decision tree is a tree structure with interrogatory nodes starting from root all the way down to penultimate nodes—before hitting the leaf nodes. Depending on the input, a unique path along which input satisfies one and only one branch at each interrogatory node (and fails all other branches at that node) is generated. At the leaf node the tree outputs the path from the root to the leaf node. This path is an important Secondary-Feature for the third and last component in the learning unit, for example the layered neural net.

The inputs to the neural net are, for example: known border energy values, and Primary- and Secondary-Feature. Its outputs are estimation of unknown energies at sites within Tile such as the sites with question marks or symbol F in FIG. 18—referred to in the encoder, decoder algorithms as TileModel. The importance of the outputs of classifiers and numeric decision trees as Secondary-Features and as input to neural nets is that they partition the enormous solution space of all possible output energy values in TileModel to manageable and tractable sub-spaces. The existence of Secondary-Features makes the neural net simple—small number of hidden nodes and weights on links, its training more efficient and its outputs more accurate.

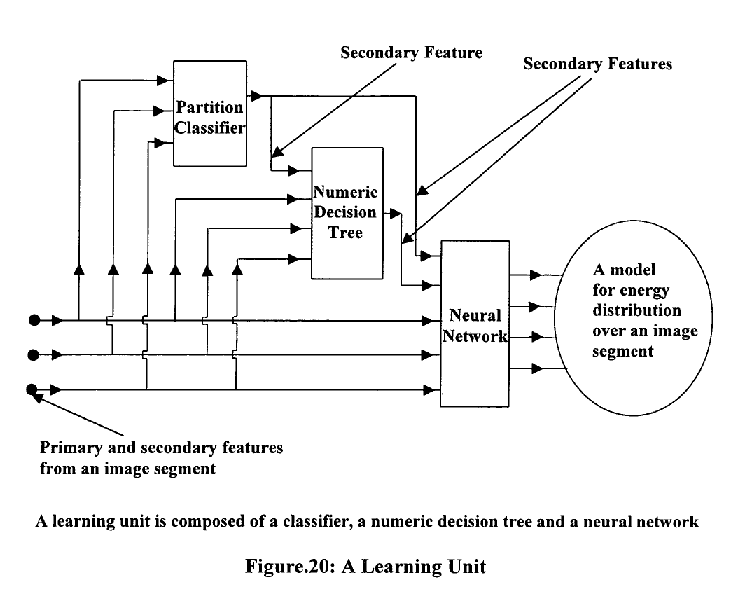

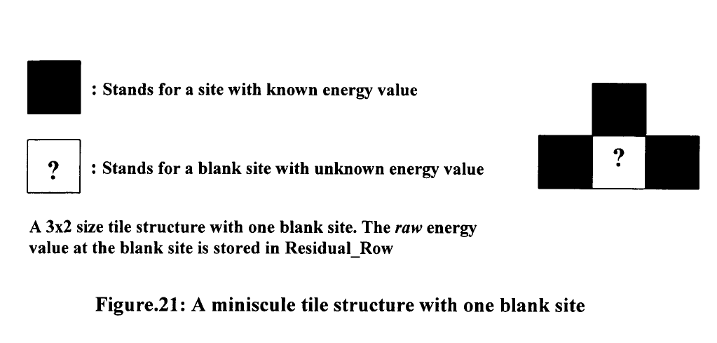

A learning unit need not necessarily consist of all the three components: classifier, numeric decision tree and neural network—although it needs at least a learning mechanism such as a neural net for tile modeling. FIG. 20 provides a schematic representation of a learning unit in the learning hierarchy with the three components: classifier, numeric decision tree and neural net in place. Information relating to Primary- and Secondary-Features are stored in Heuristic Row. Lastly, when tile size is miniscule (TileSize<MinSize), modeling terminates and instead raw energy values within tile boundary are stored in Residual Row. FIG. 21 shows one such miniscule structure with one raw energy value symbolized with the question mark.

Finally, lossless compression methods such as runlength, differential and Huffman coding are applied to compress Binary Tree Bits, Energy Row, Heuristic_Row and Residual Energy. They are then appended to each other and returned as Data Row for storage or transmission.

We now discuss the decoder. The decoder retracts the compression processes performed at the encoder. First, it has to decompress Data Row using the decompression parts of the lossless coding techniques. Next, Data Row is broken back into its constituents, namely: Binary Tree Bits, Energy Row, Heuristic Row and Residual Energy. At the decoder side, initially the image frame is completely blank. The task at hand is to use the information in Binary Tree Bits, Energy Row, Heuristic Row and Residual Energy to Paint the blank image frame and finally return the Image-Reconstruction. The image frame is painted iteratively and to stage by stage using Binary Tree Bits. The while loop in the decoder algorithm keeps drawing single bits from Binary Tree Bits one at the time. A bit value of 1 implies a TerminalTile, thus terminating Binary Tree Bits expansion at the node where TerminalTile is represented. Otherwise, bit value is 0 and Tile is non-terminal, hence Binary Tree Bits is expanded one level deep.

In case of a non-terminal Tile (bit value 0), if the energy value corresponding to its apex does not exist in the image frame, an energy value (ApexEnergy) is fetched from Energy Row and placed in the image frame at the apex of Tile. In case of a TerminalTile, the vertex energy values (VertexTileEnergies) as well as (x, y) vertex coordinates are all known and used to Paint the Tile. Initially when the while loop begins, three energy values (E₁₄, E₁₂, E₁₃ in FIG. 11) are taken out of Energy Row to fill up the pixel sites at (X₁, Y₁), (0, Y₁) and (0, 0) in FIG. 11. From then on, each non-terminal tile asks for one energy value from Energy Row providing there is no energy in the image frame corresponding to the apex of Tile. If TerminalTile is sufficiently large (TileSize≧LowSize), similar to encoder side, the Planarization scheme is enforced to Paint the region of the image within the tile using the equation of the plane optimally fitting TerminalTile vertices. If TerminalTile is mid-range (TileSize≧MinSize), then information from Heuristic Row is gathered to compute Primary- and Secondary-Features, which are then used in addition to VertxTileEnergies to activate the appropriate learning units in the appropriate layer of learning hierarchy. TerminalTile is then Painted with TileModel energy values.

If TerminalTile is miniscule (TileSize<MinSize), raw energy values corresponding to sites within Tile are fetched from Residual Energy and used to Paint TerminalTile.

The while loop in the decoder algorithm terminates when image frame is completely Painted. At that juncture, Image-Reconstruction is returned.

Class-Based 2-Dimensional Modeler and Coder

The present system includes a class-based 2-dimensional modeler and coder and the description below is to develop a pattern driven class-based compression technology with embedded security.

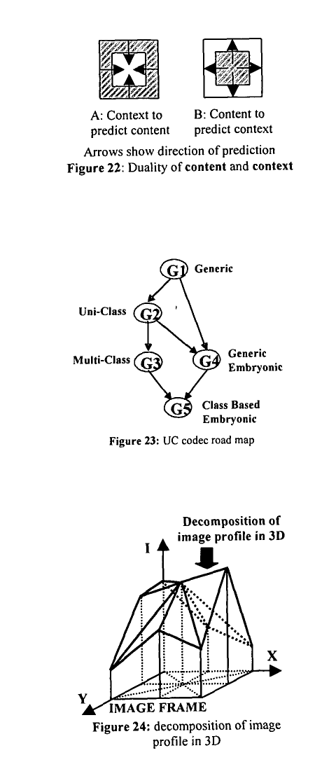

Current image compression technologies are primarily data-driven, and as such they do not exploit machine intelligence to the extent that a content/context-driven, collectively called pattern-driven, codec can offer. FIG. 22 exhibits the duality of content vs. context. In part A of FIG. 22, one employs contextual knowledge in the image (blue/hatched) to correlatively predict an accurate model for the patterns internal to the surrounded (white) area—this being the inward prediction as the arrows indicate. Linear transformation methodologies (e.g., DCT, Wavelet) are weakly context-dependent as adjacent regions are in general regarded independently or at best loosely dependent. Such methods do effectively compress uniform and quasi-static regions of the image where contextual knowledge can be ignored. For regions where extensible visual patterns such as edges and crosses emerge, objects preponderantly cross borders from surrounding to the interior of image segment. It is unfortunately here that classical methods lose their predictive power as they are in principle impotent to training on visual patterns and thus need to penetrate to pixel level for high reconstruction quality (RQ) at the expense of lowering compression ratio (CR). Even if one assumes contextual knowledge, one requires not only the tools from classical methods, but also a good deal of domain specific psycho-visual knowledge and above all the latest state of the art in computational intelligence particularly statistical machine learning. Part B of FIG. 22 is the dual counterpart of part A, namely, once predicted a region becomes context to predict unexplored regions of the image—this being the outward prediction as the arrows indicate. An intelligent and adaptive compressor should employ this context-content non-linear propagation loop to offer superior compression performance (CR, RQ, T), where T stands for computational efficiency.

Trainability on and adaptation to visual patterns, as is with the present method, has ushered in species of novel compression ideas. These new ideas include (1) the development of class based intelligent codec trained on and adapted to a foray of multiple classes of imagery, and (2) the development of embryonic compressor shell, which dynamically generates a codec adapted to a set of imagery. FIG. 23 shows a roadmap by which various generations of intelligent codec can be developed, each codec with benefits of its own, while at the same time advancing to the next generation(s).

There is a rational for class-based compression. According to our research, images exhibit three major structural categories: (1) uniform and quasi-statically changing intensity distribution patterns (data-driven methods such as J/MPEG compresses these effectively), (2) primitive but organized and trainable parametric visual patterns such as edges, corners and strips (J/MPEG requires increasingly higher bit rate), and (3) noise-like specks. The present codec includes a denoising algorithm that removes most of the noise leaving the first two categories to deal with. Also, an algorithm has been developed to compute a fractal dimension of an image based on Peano-Cezaro fractal, and lacking a better terminology, it is referred to as “image ergodicity”. Ergodicity's range is from 1 to 2 and it measures the density of primitive patterns within a region. Ergodicity approaching 2 signifies dense presence of primitive patterns whereas when approaching 1 it represents static/uniform structures. Interim values represent a mixture of visual patterns occurring to various degrees. At the boundary values of the ergodicity interval, the compression technology set forth here and data-driven methods are in most cases comparable. However, in between ergodicity values, where there is “extensibility” of patterns like edges and strips, the present system exhibits considerable superiority over other approaches. Fine texture yields high ergodicity. However, the exceptional case of fine regular texture is amenable to machine intelligence and we will certainly consider such texture as part of its primitive patterns to be learnt in order to gain high compressions. As the mapping: image domain→ergodicity is many-to-one, where image domain is the set of all images, ergodicity alone is not a sufficient discriminator for finer and more homogenous image classification. As such one requires variety of primitive patterns, their associated attributes/features and the range of values they are bounded by—such an attribute is referred to as “parametric”. In the case of an edge, five possible attributes may be of interest, namely: position, orientation, length, left-side-intensity and right-side-intensity, each parameterized by ranges of values and to be intrinsically or extrinsically encoded by learning mechanisms. The relative frequencies of the primitive patterns are also important in classification of images. An in-depth study of the descriptors that robustly classify imagery is vital to (1) significantly enhance compression performance, (2) automatically (and as a by product) offer an embedded security, (3) lay a solid foundation for the embryonic compressor shell mentioned above, and (4) similarly lay a solid foundation for a set of intelligent imaging solutions including object/pattern recognition; and image/video understanding, mining and knowledge discovery. There are five generations of intelligent adaptive codec that we would like to develop.

The first generation G1 codec is expected to be a generic codec that may be trained on a hybrid of classes of imageries, which is expected to outperform data-driven counterparts by as much as 400%. Lacking a classification component, the codec would be adapted to the pool of primitive patterns across the classes of images and does not offer an embedded security. Some of the key issues in the G1 generation are to verify that (1) using machine intelligence, one is able to significantly improve upon the predictive power of encoding well beyond the current data-driven methods, and (2) neighbor regions are tightly correlated thus reinforcing contextual knowledge for prediction. The knowledge and expertise gained in G1 has a key impact on developing a uni-class based codec G2 and the generic embryonic compressor shell G4 (see FIG. 23).

The second generation G2 codec is expected to be a uni-class based codec that would be trained on primitive patterns specific to a class of imagery. Because of its specificity, a class dependent codec is expected to offer significant compression performance (estimated to be of the order of 600%) over data-driven technologies. Equally important is the embedded security that results from having the compressor trained on specific set of images generating unique bit sequences for that class. Clearly, in a situation with a number of different indexed classes, a collection of uni-class codecs each trained on a class may offer enhanced compression over G1, complimented by embedded security. However, the collection may not be an integrated entity and requires the images to already have been indexed. G2 is expected to have a key impact on developing a multi-class based codec G3 and the generic embryonic compressor shell G4 (see FIG. 23).

The third generation G3 codec is expected to be a multi-class based codec with an inbuilt classifier trained on primitive patterns specific to the classes. At runtime, the codec would classify the image and compress it adaptively. In contrast to a collection of uni-classes, a G3 codec would be an integrated entity which, similar to G2, would offer embedded security and enhanced compression performance. The development of G3 would have a key impact on developing the class based embryonic compressor shell G5 (see FIG. 23).

The fourth generation G4 codec is expected to be a generic embryonic compressor shell that dynamically generates a codec fully adaptive to a multi-class imagery. The shell is expected to be a piece of meta-program that takes as input a sample set of the imagery, generates and returns a codec specific to the input class(es). The generated codec is expected to have no classifier component built into it and hence would offer compression performance comparable to G1 or G2 depending on the input set. Clearly, G4 would offer embedded security as in G2 and G3. The development of G4 is expected to have a key impact on developing the class based embryonic compressor shell G5.

The fifth generation G5 codec is expected to be a class-based embryonic compressor shell that dynamically generates a codec with an inbuilt classifier fully adaptive to a multi-class imagery. The shell is expected to be a piece of meta-program that takes as input a sample set of the imagery, generates and returns a codec with a classifier component specific to the input class(es). The generated codec offers expected compression performance comparable to G3 and embedded security as in G2, G3 and G4.

Table 1 summarizes the anticipated progressive advantages of the present system's five generations of codec.

TABLE 1
Progressive capabilities and advantages of G1, G2, G3, G4 and G5 generations codec

| | | | | | G5 - Class- |
|---|---|---|---|---|---|
| | | | G3 - Multi- | G4 - Generic | Based |
| | G1 - Generic | G2 - Uni-Class | Class | Embryonic | Embryonic |
| Compression | ˜400% | ˜600% | ˜600% | ˜600%: uni-class | ˜600% |
| Ratio (CR) | improvement | improvement over | improvement | ˜400%: multi- | improvement |
| | over J/MPEG | J/MPEG | over J/MPEG | class improvement | over J/MPEG |
| | | | | over J/MPEG | |
| Reconstruction | ˜30 dB | ˜30 dB | ˜30 dB | ˜30 dB | ˜30 dB |
| Quality (RQ) | | | | | |
| Computational | O(n log n) | O(n log n) | O(n log n) | O(n log n) | O(n log n) |
| Complexity (T) | | | | | |
| Embedded | NO | YES | YES | YES | YES |
| Security | | | | | |
| Adaptive | Semi | Fully | Fully | Fully: uni-class | Fully |
| capability | | | | Semi: multi-class | |
| Classification | NO | NO | YES | NO | YES |
| capability | | | | | |
| Dynamic codec | NO | NO | NO | YES | YES |
| generation | | | | | |

In Table 1, n is the number of image pixels, and O(n log n) is the worse case computational complexity.

Over and above Table 1, the present codec provides the following compression advantages:
Are applicable to still, motion and volumetric pictures
Are applicable to gray scale and color images
Offer adjustable RQ to any desirable fidelity
Exhibit graceful degradation due to learning and adaptation
CR increases with image size (in contrast, CRJPEG≈constant)
Can zoom in on any region for enhanced quality
Are capable to resize image at the decoder
Decoder is considerably faster than the encoder
Progressively reconstructs image
Are deployable as software, hardware or a hybrid
Are amenable to parallel computation

The present codec conceives an image as a decomposition hierarchy of patterns, such as edges and strips, related to each other at various levels. Finer patterns appear at lower levels, where the neighboring ones get joined to form coarse patterns higher up. To appreciate this pattern-driven (class-based) approach, a short summary is set forth below.

The present codec implements a compression concept that radically digresses from the established paradigm where the primary interest is to reduce the size of (predominantly) simple regions in an image. Compression should be concerned with novel ways of representing visual patterns (simple and complex) using a minimal set of extracted features. This view requires application of Artificial Intelligence (AI), in particular statistical learning, to extract primitive visual patterns associated with parametric features; then training the codec on and generating a knowledge base of such patterns such that at runtime coarse grain segments of the image can be accurately modeled, thus giving rise to significant improvement in compression performance.

The generic codec G1 seeks a tri-partite hierarchical filtering scheme, with each of the three filters having a multiplicative effect on each other. Filter1, defining the top section of the hierarchy and itself composed of sub-filters, introduces a space-filling decomposition that, following training, models large image segments containing simple structures at extremely low costs. Next in the hierarchy is Filter2 composed of learning mechanisms (clustering+classification+modeling) to model complex structures. The residual bit stream from Filters1&2 is treated using Filter3. Such a division of labor makes the compressor more optimal and efficient.

The present codec views an image as a 2D-manifold orientable surface I=I(x, y) mapped into 3D space (X, Y, I), where xεX and yεY are pixel coordinates and I the intensity axis. A space-filling curve recursively breaks the image manifold into binary quadratic tiles with the necessary properties of congruence, isotropy and pertiling. These properties ensure that no region of image has a priori preference over others. FIG. 24 depicts decomposition of image frame into binary triangular tiles and their projection onto the manifold. A binary tree can represent the decomposition where a node signifies a tile and the pair of links leaving the node connects it to its children. A tile is terminal if it accurately models the portion of the image it covers, otherwise it is decomposed.

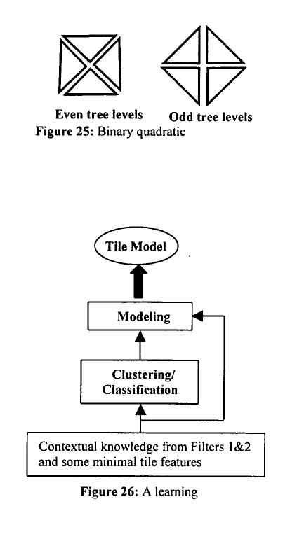

In contrast to quadtree decomposition, where the branching factor is four, binary quadratic decomposition is minimal in the sense that it provides greater tile termination opportunity, thus minimizing the bit rate. The decomposition also introduces four possible decomposition directionalities and eight tile types, shown in FIG. 25, thus giving tile termination even greater opportunity. On the other hand, quadtree introduces only two decomposition directionalities and one tile type.

Linear and Adaptive Filter1 replaces coarse grain variable size tiles, wherein intensity changes quasi statically, with planar models. This models by far the largest part of image containing simple structures. Filter1 undergoes training and optimization techniques based on tile size, tile vertex intensities and other parameters in order to minimize the overhead composed of bits to code the decomposition tree and vertex intensities required to reconstruct tiles.

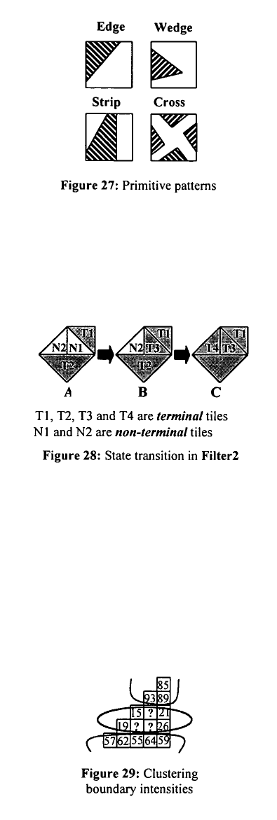

Non-linear Adaptive Filter2 models complex but organized structures (edges, wedges, strips, crosses, etc.) by using a hierarchy of learning units performing clustering/classification and modeling tasks, shown in FIG. 26. FIG. 27 illustrates a few primitive patterns. In the present codec, organized structures are amenable to pattern-driven compression consuming minimal overhead. This belief is founded on heuristics that are well grounded in neurosciences and AI such as the evolution of neural structures that are specialized in recognizing high frequency regions such as edges. Since Filter1 skims out simple structures, it is heuristically valid to deduce that tiles in Filter2 contain predominantly intensity distribution patterns that exhibit structures such as edges. Therefore, similar to natural vision, Filter2 is an embedded expert system that proficiently recognizes complex patterns. It is this recognition capability that is expected to significantly elevate compression ratios of generic codec G1 of the present system.

Tiles in Filter2 are processed using a priority hash function. The priority of a tile depends on the available local information to find an accurate model—the greater the quantity of this available information the higher the chance of an accurate model and hence the higher the priority. Once modeled, a tile affects the priorities of neighboring tiles. FIG. 28 illustrates this for a simple hypothetical scenario. Given state A, non-terminal tile N1 goes in first for modeling as it has two neighboring terminal tiles T1 and T2. In comparison, N2 has only one neighboring terminal tile T2. Hence, N1 requires the least amount of features along its undetermined border with N2. The extraction of minimal (yet sufficient) features along undetermined borders, as for N1, to model tiles, is one focus of the present system. The objective here is to model tiles subject to minimum number of bits to code features. In State B the priority of the only non-terminal tile N2 increases since it has now more available information from its surrounding terminal tiles T2 and T3 than in State A. Finally, in State C all tiles are terminal.

Contrary to data driven compression methods where adjacent tiles are loosely dependent, in the present codec, tiles are strongly correlated as indicated with respect to FIG. 22, where surrounding modeled tiles act as context to model a tile under examination. A theorem based on tile correlation proves that the present compression technology at worst linearly increases with the accumulated overhead—in contrast to JPEG where CR is on average constant per image.

Filter2 is hierarchical, wherein each layer corresponds to a level in decomposition tree where Filter2 applies. A layer in the hierarchy is composed of a number of learning units each corresponding to a specific tile size and availability of neighboring information. Alternatively a general purpose learning mechanism can handle various tile sizes and neighboring structures.

As shown in FIG. 26, a learning unit in the hierarchy integrates clustering/classification and modeling components.

Intense research is currently underway with respect to the present codec on the clustering/classification component with pursuit of at least a few lines of inquiry. In broad terms, the clustering/classification algorithm takes the available contextual knowledge, including border and possibly internal pixel intensities of a tile and returns (1) a class index identifying the partition of borders intensities into homologous sets, (2) a signature that uniquely determines the pertinent features present in the tile, and (3) first and second order statistics expressing intensity dynamics within each set component of the partition. The signature in (2) above should contain the minimal but sufficient information, which the modeling component in the learning unit can exploit to estimate unknown pixel intensities of the tile under investigation. The minimization of the signature is constrained by the bits that would alternatively be consumed if one was to further decompose the tile for modeling. Tile ergodicity does provide knowledge on how deep the decomposition is expected to proceed before a model can be found. In that fashion the bits required to encode the signature must be much smaller than the bits required to decompose the tile. If such a signature does exist and is returned by the clustering/classification algorithm, the learning unit then goes to the next phase of modeling, following which boarding tile priorities are updated. Otherwise tile is decomposed one level deeper to be considered later. In FIG. 29, the partition is: (89, 85, 93), (21, 26, 19, 15) and (59, 64, 55, 62, 57), where each set has a very small dynamic range. A 5×5 tile (FIG. 29) yields over 300 classes whereas a 9×9 tile yields over 2000 classes.

There exist a number of supervised and unsupervised learning methodologies that are capable of handling the associated clustering/classification tasks, such as, K-Means Clustering, Mixture Models (e.g., Mixture of Gaussians Models), Numeric Decision Trees, Support Vector Machines, and K-Nearest Neighbors algorithms.

The second component in a learning unit does modeling, such as a neural net with inputs: border intensities, tile features, class index and partition statistics, all from the clustering/classification component. The outputs are: estimations for unknown intensities in the tile. Introduction of the outputs of the clustering/classification component to the modeling learning mechanism such as a neural net (see FIG. 26) as a priori knowledge is crucial in directing search to the relevant region of enormous solution space. For instance, the combinatorial number of intensities for 12 border sites (without the clustering/classification) is of the order of 25612. With a clustering/classification this number reduces to the order of 2563. Statistical information on set partitions further reduces this to ˜103. Assuming CR at the deepest level (tile size 2×2) is CRMIN, pure nine tree rollups (assuming no overhead) to tile size 17×17, yields CRMAX=CRMIN*28. The challenge of Filter2 is to get CR as closely to CRMAX as possible. Estimates indicate that at the deepest level, rollup factor is close to 1.9 and that this decreases at higher levels. Assuming a low rollup factor of 1.1 at the highest level and using a conservative linear distribution amongst the nine levels gives rise to a combined factor greater than 24 making CR≈CRMIN*24. The lowest level of the present codec may give rise to estimates of CRMIN≈4, thus resulting in CR≈64. With Filter3, the related estimate may be CR≈90. A comparable reconstruction using JPEG would produce CR≈20, less than fourth of the CR expected from the present system. Preliminary investigations of the deepest tree rollup are extremely encouraging. FIG. 30 shows an image, its reconstructions without and with deepest rollup and the estimated generic as well as class based codec estimation performance.

In a class based G2 or G3 codec, it is the higher up tree levels that get most affected as it is there that primitive patterns show large variations. For instance, an edge crossing a 17×17 size tile has more variation in terms of position, length, orientation, etc., compared to a 3×2 tile. A G2 or G3 codec drastically curtails these variations as images belonging to the same class are expected to have strong correlation in their feature values. For this very reason we anticipate that the rollup factors are larger than their counter parts in the generic case G1 for most but particularly higher levels. We estimate 50% improvements in CR compared to G1, giving rise to an estimated order of 600% increase in CR compared to data-driven technologies.

Finally, the residual overhead from Filters1&2 are fed into Filter3, which is a combination of well-established low-level data compression techniques such as run-length, Huffman/entropy and differential/predictive coding, as well as other known algorithms to exploit any remaining correlations in the data (image subdivision tree or coded intensities).

The present compression system is based on the following heuristics:

Heuristic 1: Structurally, images are meaningful networks of a whole repertoire of visual patterns. An image at the highest level is trisected into regions of (1) simple, uniform and quasi statically changing intensities, (2) organized, predictable and trainable visual patterns (e.g., edges), and (3) marginal noise.

Heuristic 2: Contextual knowledge improves codec predictive power.

Heuristic 3: Statistical machine learning is the most optimal forum to encode visual patterns.

Current indications and related investigations validate the above heuristics.

Heuristic 4: In a G1 codec, primitive patterns are considered rectilinear. Mathematically, continuous hyper-surfaces can be modeled to any degree of accuracy by rectilinear/planar approximation. However, this is restrictive, because to get an accurate model, patterns with curvature need to be sufficiently decomposed to approximate well. The present codec will relax rectilinearity by introducing curvature and other appropriate features. Curvilinear modeling should raise CR.

Heuristic 5: Predictable patterns are defined by parametric features (i.e., a corner is defined by: position, angle, orientation, intensity contrast), learnt intrinsically or extrinsically by the learning mechanism and that in certain classes of imagery features predominantly exhibit a sub-band of values. This finding is expected to considerably raise CRs beyond what is achievable by G1.

FIGS. 31 and 32 are two images with distinct and well-structured patterns. In FIG. 31 most edges are vertical, some horizontal and corners are mostly right-angle. This knowledge can make considerable impact on the CR. The same reasoning applies to FIG. 33 although here the ergodicity is greater implying more variety. Current investigations are expected to verify that a specific class of imagery does demonstrate preponderance in sub-bands of feature values, thus corroborating Heuristic 5, and may use this to create a class-based code G2. For each image in the class and at each decomposition tree level in Filter2, statistics and data may be collected to explore the preponderance of feature sub-bands. This information may then be exploited to minimize the overhead to encode the features.

Heuristic 6: Images can be classified based on the statistics of the visual patterns therein and their classification can be used as a priori knowledge to enhance compression performance and provide embedded security.

Three avenues of investigation present themselves. The first and the easiest route is to build the multi-class based codec as a collection of uni-class based codecs. For this system to work, the classifier is an external component and is used to index the image before it is compressed. The index directs the image to the right codec. The downside of such a codec is that (1) it may be large, and (2) would require a class index. In the second route, the codec is a single entity constituting a classifier and a compressor that integrates overlapping parts of the program in the collection of the uni-class based codecs. The third and apparently smartest route is the subject matter of heuristic 7 below.

Heuristic 7: Within an image, different regions may exhibit different statistics on their primitive patterns and thus be amenable to different classes. It is plausible to have the classifier and the compressor fused into one entity such that as image decomposition proceeds, classification gets refined and in turn compression gets more class based. In such case, as the image (FIG. 33) is decomposed for compression, different regions can be de/compressed by corresponding class based compressors.

There are of course images with high ergodicity, such as in FIG. 34, that do not admit to a significant correlation in some sub-bands of feature values. Such images are not suitable for class based codec and are best compressed using a G1 codec.

Heuristic 8: Pattern-driven codec can be automatically generated by an embryonic compressor shell. An ultimate goal of the present system is to build an embryonic compressor shell that would be capable of generating G1, G2 or G3.

With respect to related matters, segmentation is commonly used in image classification and compression as it can help uncover useful information about image content. Most image segmentation algorithms are based on one of two broad approaches namely, block-based or object-based. In the former, the image is partitioned into regular blocks whereas in an object-based method, each segment corresponds to a certain object or group of objects in the image. Traditional block-based classification algorithms such as CART and vector quantization ignore statistical dependency among adjacent blocks thereby suffering from over-localization. Li et al. have developed an algorithm based on Hidden Markov Models (HMM) to exploit this inter-block dependency. A 2D extension of HMM was used to reflect dependency on neighboring blocks in both directions. The HMM parameters were estimated by EM algorithm and an image was classified based on the trained HMM using the Viterbi Algorithm. Pyun and Gray have produced improved classification results over algorithms that use causal HMM and multi-resolution HMM by using non-causal hidden Markov Gaussian mixture model. Such HMM models with modifications can be applied to the present system's recursive variable size triangular tile image partitioning. Brank proposed two different methods for image texture segmentation. One was the region clustering approach where feature vectors representing different regions in all training images are clustered based on integrated region matching (IRM) similarity measure. An image is then described by sparse vector whose components describe whether, and to what extent, regions belong to a particular cluster. Machine learning algorithms such as support vector machines (SVM) could then be used to classify regions in an image. In the second approach, Brank used the similarity measure as a starting point and converted it into a generalized kernel for use with SVM. Generalized kernel is equivalent to using an n-dimensional real space as the feature space, where n is the number of training examples, and mapping an instance x to the vector φ(x)=(K (xᵢ, x))ᵢ where K is some similarity measure between instances (images in the present system's case). A number of image compression methods are content-based. Recognition techniques are employed as a first step to identify content in the image (such as faces, buildings), and then a coding mechanism is applied to each identified object. Using machine learning concepts, the present system will seek to extract hidden features that can then be used for image encoding. Mixture density models, such as Mixture of Probabilistic Principal Component Analysis (MPPCA) and Mixture of Factor Analyzers (MFA), have been used extensively in the field of statistical pattern recognition and in the field of data compression. The major advantage with these approaches is that they simultaneously address the problems of clustering and local dimensionality reduction for compression. Model parameters are then usually estimated with the EM algorithm. Ghahramani et al. developed separate MFA models for image compression and image classification. The MFA model, used for compression, employs block-based coding, extracts the locally linear manifolds of the image and finds an optimum subspace for each image. For image classification, once an MFA model is trained and fitted to each image class, it computes the posterior probability for a given image and assigns it to the class with the highest posterior probability. Bishop and Winn provided a statistical approach for image classification by modeling image manifolds such as faces and hand-written digits. They used mixture of sub-space components in which both the number of components and the effective dimensionality of the sub-spaces are determined automatically as part of the Bayesian inference procedure. Lee used different probability models for compressing different rectangular regions. He also described a sequential probability assignment algorithm that is able to code an image with a code length close to the code length produced by the best model in the class. Others (e.g., Ke and Kanade) represented images with 2D layers and extracted layers from images which were mapped into a subspace. These layers form well-defined clusters, which can be identified by mean-shift based clustering algorithm. This provides global optimality which is usually hard to achieve using E-M algorithm.

Research regarding the present codec will explore, expand, adapt and integrate the most promising image clustering and classification algorithms reviewed above in its pattern-driven compression technology to produce significantly more efficient class based codec.

3-Dimensional Modeler and Coder

The present modeling/coding system offers a 3-dimensional modeler and coder and a novel, machine-learning approach to encode the geometry information of 3D surfaces by intelligently exploiting meaningful visual patterns in the surface topography through a process of hierarchical (binary) subdivision.

The most critical user need is to reduce the file sizes of very large or high definition surface and volumetric datasets (often multi-gigabyte) required for real-time or interactive manipulation and rendering. Typical examples of large datasets are seismic data for oil and gas exploration and volumetric medical data such as magnetic resonance imaging (MRI). Because almost all current PCs are limited to 32 bit memory addressing (4 Gb of RAM), specialized and costly workstations are often required to render these datasets. As Table 2 shows, even modestly sized 3D imagery consumes enormous amounts of storage and hence bandwidth.

TABLE 2
Comparison of 3D data requirements

| Data type | Kbytes | Number of pages |
|---|---|---|
| One page text | 7 | 1 |
| Gray scale image (512 × 512 pixels) | 262 | 37 |
| Cubic surface image (512 × 512 × 6) | 1,573 | 217 |
| Cubic data (512 × 512 × 512) | 134,218 | 18,650 |
| Cubic surface video clip - 5 min | 14,155,776 | 1,966,667 |
| (512 × 512 × 6 × 5 × 60 × 30) | | |

Table 2 does not even address color which would multiply the data sizes by an order of 3. Given 3D's costly requirements and the fact that current 3D modeling and compression approaches are still in their infancy, better compression techniques and approaches are essential in advancing 3D surface and volumetric modeling and visualization. The present 3D modeling/coding system provides new modeling and compression methods for surfaces and volumes and will be instrumental in creating compact, manageable datasets that can be rendered real-time on affordable desktop platforms.

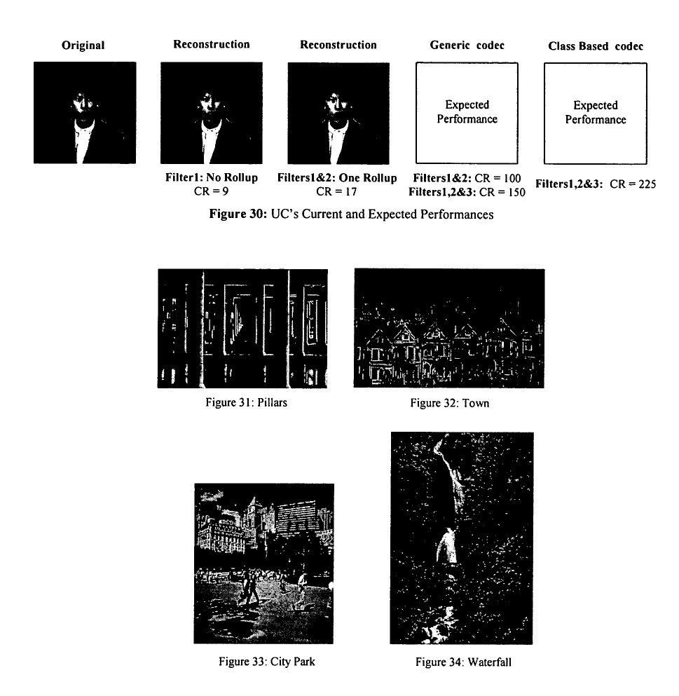

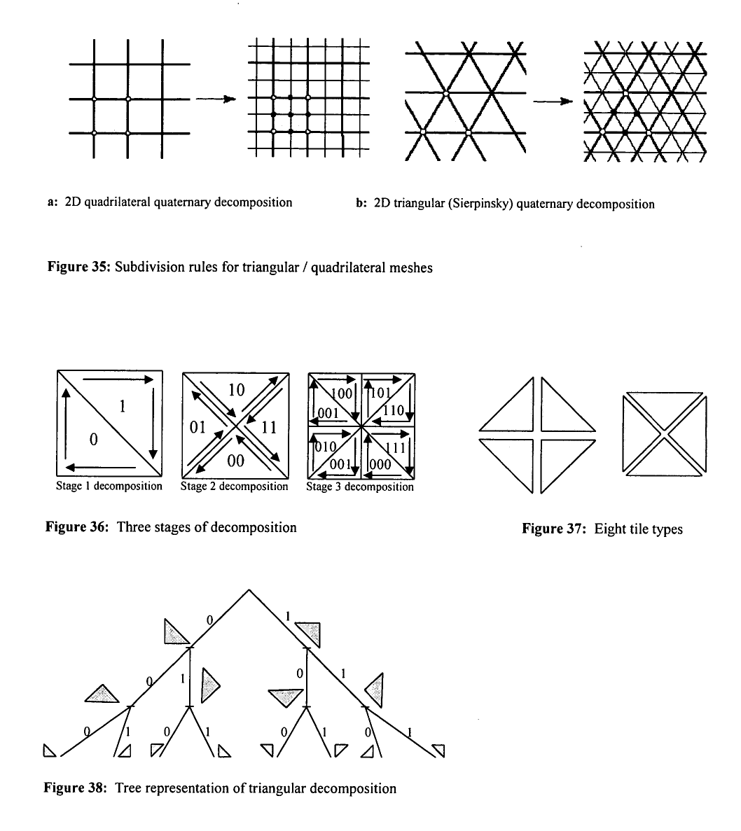

Within the context of “digital geometry processing”, following discretization and digitization, a surface in 3D space is commonly represented by a mesh, i.e. a collection of vertices Xᵢ=(xᵢ, yᵢ, zᵢ) together with (un-oriented) edges (Xᵢ-Xⱼ) forming the connectivity of the mesh. Inherent in such a representation is a certain degree of approximation as well as a model of the surface as a collection of planar regions. Meshes are triangular, quadrilateral or hybrid depending on whether the tiles (alternatively referred to as faces), bounded by edges, are triangular, quadrilateral, or a mixture of both (and other) shapes. Meshes constructed by successive refinements following simple rules have the property that the connectivity (number of neighbors) is the same at almost every vertex in the mesh—such a meshing is traditionally called semi-regular. FIG. 35 shows regular quaternary quadrilateral and triangular decompositions where, in the case of the quadrilateral, a square is subdivided into quadrants whereas in the case of the triangular, a triangle is subdivided into four sub-triangles. Any (hybrid) mesh can in principle be made triangular by simply adding more edges; the process of remeshing a surface in a semi-regular fashion is more involved but well studied—remeshing is the process of mapping one set of vertices and edges to another set.

It is clear from the above description that the vertex-edge representation of a reasonably complex surface involves a considerable amount of data, a great deal of which is highly correlated and redundant, thus making its compression the topic of continuous research for the past several years.

Whereas earlier work in the art was largely focused on encoding the connectivity information of a mesh, a landmark paper by Witten et al. combined state-of-the-art compression performance with progressive reconstruction, a feature just as desirable and important in surface coding as it is in 2D still image coding. The new approach, building upon previous work for single-rate coding of a coarse mesh and progressive subdivision remeshing, featured the use of a semi-regular mesh to minimize the “parameter” (related to vertex location along the surface's tangential plane) and “connectivity” bits, focusing on the “geometry” part which was encoded by making use of: local coordinates (significantly reducing the entropy of the encoded coefficients); a wavelet transform, adaptable from the plane to arbitrary surfaces; and its companion technique zerotree coding.

The next breakthrough, and possibly the current state of the art, differs in several respects from the works mentioned above. First and foremost, the problem addressed is slightly different as the surface is assumed to be presented in the form of an isosurface implicitly defined as the locus
S={(x,y,z)|ƒ(x,y,z)=0}
of zeros of a function ƒ given by its values on a fine, cubic, uniform sampling grid. This assumption is rather a generalization than a restriction since many complex surfaces are given in this format and only subsequently, if necessary, turned into a mesh representation using such methods as “marching cubes” or otherwise. Once again, while allowing progressive reconstruction, the algorithm achieves rate/distortion curves similar to or better than the existing methods, including those designed for isosurfaces and single-rate (as opposed to progressive) encoders. Its main features are the use, for progressive reconstruction, of an adaptive hierarchical (“octree”) refinement of the cubic grid encasing the surface, and a scheme which takes advantage of the resulting hierarchy to more efficiently encode the function's signs at all relevant vertices. However, a disadvantage of the scheme is that the purely “geometric” information (in the sense of Khodakovsky et al.), which describes the exact surface location within each cube (voxel) at the finest resolution, still takes up the major part of the bitstream (5.45 out of an average of 6.10 bits/vertex), even though the visual improvement brought by this information does not (always) appear that significant—in some cases avoiding altogether the need for further refinement.

The last statement strongly suggests that while current techniques are efficient in encoding parameter/connectivity information, significant progress can (and possibly must) be made on the geometric front. For this essentially localized problem, wavelet as well as other 2D techniques may be applied. However, the present system proposes a significantly more powerful compression technique based on artificial intelligence (AI), and in particular statistical machine learning (ML), to train a system that can efficiently recognize and reconstruct surface behavior (both in smooth areas and around creases or edges) found in most common structures. The same underlying research is applicable to 3D object recognition and understanding. Additional ongoing development is being pursued with respect to the application of related ideas to 2D imagery and initial results are greatly encouraging.

The present system addresses limitations in current 3D modeling and compression methods mentioned above by creating alternative technologies that exhibit significant improvements in reconstruction quality (RQ), computational efficiency (T) and compression ratio (CR).

Within the 3D coding scheme set forth herein, whether surface or volumetric, there are two components to consider:

1—Decomposition

a. Apply tetrahedral decomposition to reduce global topology of the modeled object to a set of spatially related local geometries. Tetrahedral decomposition is applicable to surface and volume coding
b. Apply triangular binary decomposition to each coarse-level tile in the case of surface coding.
   2—Computational Intelligence

Apply artificial intelligence and machine learning to model tiles at the coarsest possible levels.

For surface modeling and coding in 3D space, one of the key features of the technology of the present system is its binary triangular decomposition of the image (or surface patch) with crucial minimality properties. FIGS. 36, 37 and 38 illustrate three stages of the triangular decomposition, tile labeling, the fractal pattern indicating the order of tile visits, the tree representation and the eight tile types. The present system includes efficient algorithms to compute the inheritance labels (FIG. 36) of all the adjacent tiles of a tile (not necessarily at the same tree level), given its inheritance label. In fact with a tile's inheritance label, the present modeling and coding system can gain information about its ancestry, connectivity, position, size, vertex coordinates, etc.

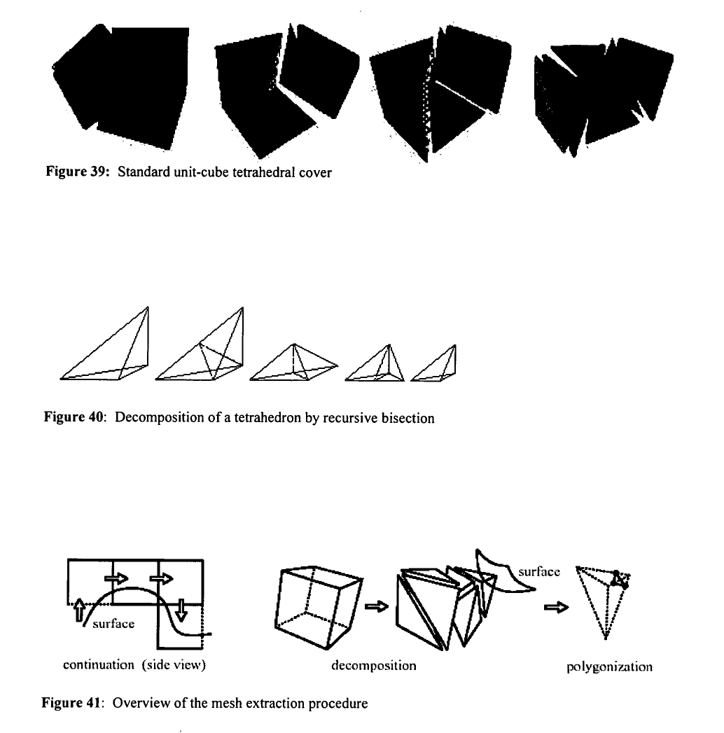

In 3D, the natural extension is the recursive tetrahedral decomposition of the cube. FIGS. 39 and 40 respectively illustrate the decomposition of the cube into six tetrahedra and the step-wise binary decomposition of a tetrahedron until reemergence of its scaled down version. Recursion in tetrahedral decomposition is more complex than triangular as it requires three tree levels (compared to one in triangular) before patterns recur. Tetrahedral decomposition was featured, for example, in the “marching tetrahedra” algorithm used for mesh extraction from isosurface data. More specifically, the decomposition relevant to the present system is that described in Maubach.

Below is a list of some of the advantages of tetrahedral and triangular decomposition.

Both triangular and tetrahedral decompositions offer an increased number of directionalities compared to quadtree and octree (respectively, 4 instead of 2 and 13 instead of 3), thus providing greater flexibility in modeling.

Both decompositions come with a unique implicit (linear) modeling of the data within each cell, which is completely in line with the present modeling and coding system's linear adaptive planar modeling.

Binary decompositions are associated with a minimality property in the sense that no single region is more finely decomposed unless otherwise required.

The tetrahedral decomposition has a built-in resolution of the “topological ambiguities” which arise in a cubic decomposition.

In both the tetrahedral and triangular decompositions, there exist implicit sweep (marching) patterns, representing the order of tile/tetrahedron visits, that provides an extremely efficient labeling scheme used to completely specify the neighborhood of a tile/tetrahedron. This turns out to be vital to (1) coding the connectivity and parameterization, and (2) applying artificial intelligence and machine learning to keep the mesh as coarsified as possible without degrading the quality.

Both triangular and tetrahedral decomposition schemes have the important properties of isotropy, congruence and (near) self-similarity.

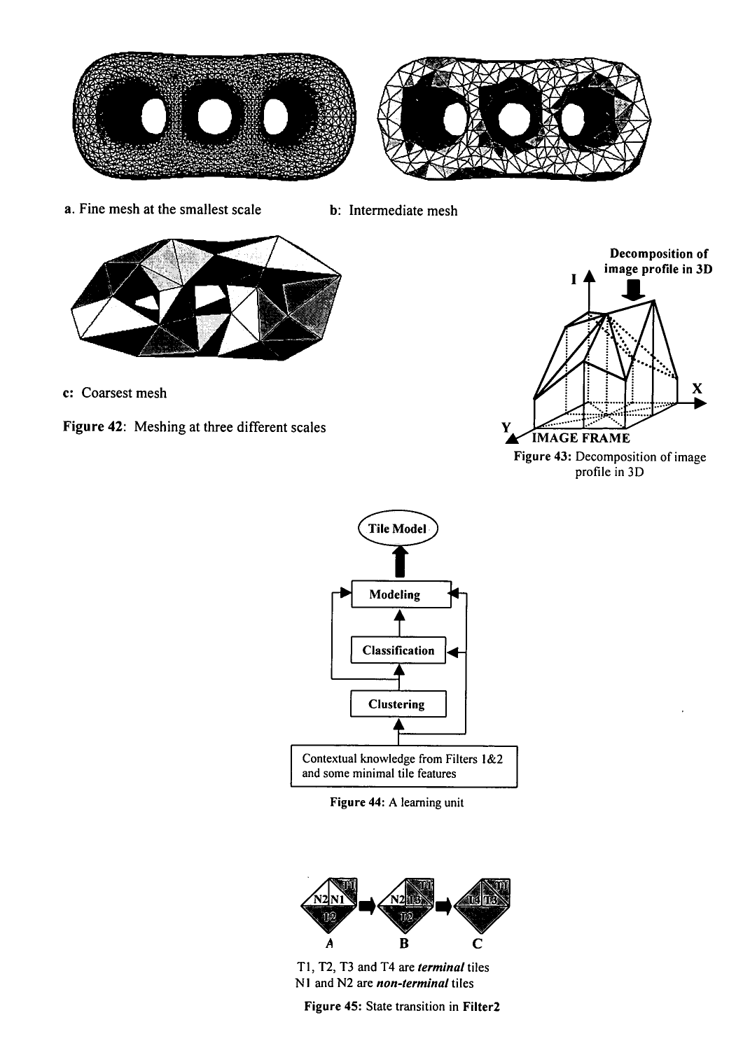

Following the decomposition process (FIG. 41), at the finest scale, the surface passes in between the vertices of the sampling grid and ends up being entrapped within a succession of tetrahedra. A progressive description is provided by a breadth-first, depth-first, or a combination of the two encoding of the tetrahedral decomposition tree—a tetrahedron has, at each of its vertices, a sign bit which indicates the position with respect to the isosurface, and mesh vertices can be interpolated or regressed on all edges whose endpoints have different signs. A complete decomposition would result, as in Lee et al. and Gerstner et al., in a fine mesh (FIG. 42a) containing a significant amount of information pertaining to geometry (besides parameter/connectivity). The present system is expected to adopt a more cost-effective strategy by transitioning early, when meshing is still coarse (FIG. 42c), to the second phase of pure geometry coding, combining novel applications of artificial intelligence and machine learning, thus avoiding redundancy between the two phases.

Therefore, the present system is expected to stop the tetrahedral refinement early on, soon after all topological information is captured by the tiling; then, within each tile, the geometry can be homeomorphically mapped onto a right-angle isosceles triangle, making the coding entirely amenable to the present system's artificial intelligence-based scheme as the geometry information takes (in local coordinates) the form of a function z=f(x,y) quite similar, both mathematically and in behavior, to the pixel intensity I=f(x,y) of an image. The subdivision scheme (FIG. 36) will eventually induce a meshing which is “semi-regular” in some sense similar to Wood et al.

Currently, the present modeling and coding system views and image as an orientable 2D-manifold I=I(x, y) mapped into 3D space (X, Y, I), where X and Y are image coordinates and I the intensity. FIG. 43 depicts the second stage of image decomposition into binary triangular tiles (see also FIG. 36) and their projection onto the manifold. A tile is terminal if it accurately models, within a certain error, the portion of the image it covers, otherwise it is decomposed. This view can be entirely carried over to patches of a surface z=f(x, y) in 3D, which can be homeomorphically mapped onto a triangle as in FIG. 43 wherein the third axis is regarded as z.

The present system pursues a tri-partite hierarchical filtering scheme, where filters exhibit multiplicative effect on each other. Filter1, defining the top section of the hierarchy and itself composed of sub-filters, employs the planar model in FIG. 43, which following training, models large image segments containing simple structures at extremely low costs. Next in the hierarchy is Filter2 composed of learning mechanisms (clustering+classification+modeling) to model complex structures. The division of labor between Filters1 and 2 makes the compressor more optimal and efficient. Finally, the residual overhead from Filters1&2 are fed into Filter3, which is a combination of well-established low-level data compression techniques such as run-length, Huffman/entropy and differential/predictive coding, as well as other algorithms to exploit any remaining correlations in the data (image subdivision tree or coded intensities).

Linear and adaptive Filter1 replaces coarse-grained, variable size tiles, wherein intensity changes quasi-statically, with planar models. This models by far the largest part of the image containing simple structures. Filter1 undergoes training based on tile size, tile vertex intensities and other parameters, which minimizes the bit rate cost function composed of bits required to code the decomposition tree and vertex intensities required to reconstruct tiles.

What is far more innovative and intricate is what takes place in Filter2. Non-linear adaptive Filter2 models complex but organized structures (edges, wedges, strips, crosses, etc.) by using a hierarchy of learning units performing clustering, classification and modeling tasks, as shown in FIG. 44, in order to effectively reduce the dimensionality of the search space. For instance, the number of possible combinations of intensities for border pixels of a small 5×5 size triangular tile (without clustering and classification components) is of the order of 256¹². With clustering this number reduces to the order of 256³. The classifier further reduces this to ˜10³. The present system operates on the premise that organized structures are amenable to pattern-driven compression consuming minimal overhead. This belief is founded on heuristics that are well grounded in neurosciences and AI such as the evolution of neural structures that are specialized in recognizing high frequency regions such as edges. Since Filter1 skims out simple structures, it is heuristically valid to deduce that tiles in Filter2 contain predominantly intensity distribution patterns that exhibit structures such as edges. Therefore, inspired by natural vision, Filter2 is an embedded expert system that proficiently recognizes complex structures. It is precisely this recognition capability that significantly elevates CR.

Tiles in Filter2 are stored in a dynamic priority queue. The priority of a tile depends on the available local information to find an accurate model—the greater the quantity of this available information the higher the quality of the model and hence the higher the priority. Once modeled, a tile affects the priorities of neighboring tiles. In stark contrast to data-driven compression methods where adjacent tiles are independent, in the present system's technology tiles are strongly correlated. FIG. 45 illustrates this for a simple hypothetical scenario. Given state A, non-terminal tile N1 goes in first for modeling as it has two neighboring terminal tiles T1 and T2. In comparison, N2 has only one neighboring terminal tile T2. Hence, N1 requires the least amount of features along its undetermined border with N2. The extraction of minimal (yet sufficient) features along undetermined borders, as for N1, to model tiles, is one focus of the present system. The objective here is to model tiles subject to minimum number of bits to code features. In State B the priority of the only non-terminal tile N2 increases since it has now more available information from its surrounding terminal tiles T2 and T3 than in State A. Finally, in State C all tiles are terminal.

Trainability and adaptation are key features that allow the present system to construct generic as well as class-based compression technologies. In the generic case, Filter2 is trained on a repertoire of primitive patterns occurring across hybrid of imagery while in the class-based technology the repertoire gets highly constrained resulting in considerable drop in bitrate. Expected to raise CR fourfold on 2D images, the same concept applied to the “geometry” component which accounts for the largest part of a compressed surface, can be naturally expected to bring a similar quantitative improvement.

The key steps in the proposed algorithm are tetrahedral decomposition, geometry coding, recursive 2D subdivision, and a non-linear, adaptive, AI-based, and trainable Filter2. In tetrahedral decomposition, the natural 3D extension of the present system's 2D subdivision scheme, generates minimal (binary) decomposition tree, automatically resolves topological ambiguities and provides additional flexibility over cube-based meshing techniques. Geometry coding is started early from a coarse mesh to take advantage of the present system's competitive advantage in 2D compression. Recursive 2D subdivision continues in the plane what tetrahedral decomposition started in 3D, adaptively subdividing regions of the surface just as finely as their geometric complexity requires. Linear Filter1 exploits any linear patterns in the data. Non-linear, adaptive, artificial intelligence-based, trainable Filter2 significantly enhances geometry compression by recognizing and modeling complex structures using minimal encoded information.

The main features of the approach used in the present system are: compression is data- and pattern-driven; two types of filters exploit different types of behavior (linear/complex but recognizable) expected in the surface data—whether the unknown function is pixel intensity or the “altitude” z, in local coordinates; correlations between neighboring tiles are strongly exploited; and geometry coding, the major bottleneck in 3D surface compression, is significantly enhanced using artificial intelligence and machine learning techniques.

Finally, the present system's approach can be easily adapted to pre-meshed input surfaces by performing first a coarsification (as in Wood et al.), thus obtaining a coarse meshing on which to apply the second part of the algorithm presented here.

Volume coding requires modeling the interior of a volume as follows:
1—Apply tetrahedral decomposition to the interior, checking each tetrahedron for modeling based on a dynamic error tolerance measure
2—Apply artificial intelligence and machine learning to model tetrahedra at the coarsest possible levels, thus maintaining low bitrate.

Before this modeling, if necessary, the volume's boundary may be modeled using the method described in the previous section.

In general, a data point in a volume is an element of a vector field, which might represent a variety of information such as temperature, pressure, density and texture, parameterized by three coordinates in most cases representing the ambient space.

A key novelty in the present system's volume coding is to extend and apply in a very natural way artificial intelligence and machine learning. In the present system's pattern-driven surface coding, artificial intelligence and machine learning considerably reduce the geometry information cost where primitive patterns such as edges, strips, corners, etc. would, using data-driven coding, require extensive tile decomposition. The parallel in 3D would be to regard concepts such as planes, ridges, valleys, etc. as primitives and apply computational intelligence to develop an embedded knowledge base system trained and proficient to model such patterns when and if required in the volume coding, hence massively reducing the bit cost.

Markets and applications for the innovations herein described include:
1—Generic still image codec
2—Generic video codec
3—Class based still image codec
4—Class based video codec
5—Generic embryonic meta-program still image codec
6—Generic embryonic meta-program video codec
7—Generic 3D still image codec include software codec
8—Generic 3D video codec include software codec
9—Generic embryonic meta-program 3D still image codec
10—Generic embryonic meta-program 3D video codec
11—Class-based embryonic metacode for 2D still
12—Class-based embryonic metacode for 2D video
13—Class-based embryonic metacode for 3D still
14—Class-based embryonic metacode for 3D video

Relevant applications and markets for the innovative technologies described include (but are not limited to) the following:

| Technology | Applications | Markets |
|---|---|---|
| 2D still and video | (1) Software codecs for personal | (1) Security & surveillance |
| | and professional computers, | (including military/defense/ |
| | wireless/mobile, consumer and | intelligence, homeland |
| | other electronic devices (e.g. | security) |
| | digital cameras, camcorders) | (2) Media & entertainment |
| | (2) Codecs integrated in | (3) Wireless |
| | embedded software/hardware | (4) Consumer electronics |
| | systems for wireless/mobile, | (5) Digital photography |
| | consumer and other electronic | (6) Medical imaging |
| | devices | (7) Distance learning |
| | (3) Chipsets for servers, | (8) Scientific and industrial R&D |
| | computers and other electronic | (9) Videoconferencing |
| | devices (e.g. digital cameras | (10) Geographic information |
| | and wireless handsets) | systems (GIS) |
| | (4) Encoding servers | |
| | (5) Streaming servers | |
| | (6) Application servers | |
| 3D still and video | (1) Software codecs for personal | (1) Visual simulation/virtual |
| | and professional computers, | reality |
| | wireless/mobile and other | (2) Geographic information |
| | electronic devices | systems (GIS) |
| | (2) Codecs integrated in | (3) Security & surveillance |
| | embedded software/hardware | (including military/defense/ |
| | systems for wireless/mobile and | intelligence, homeland |
| | other electronic devices | security) |
| | (3) Chipsets for servers, | (4) Media & entertainment |
| | computers and other electronic | (5) Consumer electronics |
| | devices | (6) Medical imaging |
| | (4) Encoding servers | (7) Distance learning |
| | (5) Streaming servers | (8) Scientific and industrial |
| | (6) Application servers | R&D |

While the present invention has been described with regards to particular embodiments, it is recognized that additional variations of the present invention may be devised without departing from the inventive concept.

1. A method for modeling data using adaptive pattern-driven filters, comprising:
applying an algorithm to data to be modeled based on an approach selected from the group consisting of:
computational geometry;
artificial intelligence;
machine learning; and
data mining; whereby
the data is modeled to enable better manipulation of the data.

2. A method for modeling data using adaptive pattern-driven filters as set forth in claim 1, further comprising:
the data to be modeled selected from the group consisting of:
2-dimensional still images;
2-dimensional still objects;
2-dimensional time-based objects;
2-dimensional video;
2-dimensional image recognition;
2-dimensional video recognition;
2-dimensional image understanding;
2-dimensional video understanding;
2-dimensional image mining;
2-dimensional video mining;
3-dimensional still images;
3-dimensional still objects;
3-dimensional video;
3-dimensional time-based objects;
3-dimensional object recognition;
3-dimensional image recognition;
3-dimensional video recognition;
3-dimensional object understanding;
3-dimensional object mining;
3-dimensional video mining;
N-dimensional objects where N is greater than 3;
N-dimensional time-based objects;
Sound patterns; and
Voice patterns.

3. A method for modeling data using adaptive pattern-driven filters as set forth in claim 1, further comprising:
the data to be modeled selected from the group consisting of:
generic data of generic nature wherein no specific characteristics of the generic data are know to exist within different parts of the data; and
class-based data of class-based nature wherein specific characteristics are known to exist within different parts of the class-based data, the specific characteristics enabling advantage to be taken in modeling the class-based data.

4. A method for modeling data using adaptive pattern-driven filters as set forth in claim 3, further comprising:
an overarching modeling meta-program generating an object-program for the data.

5. A method for modeling data using adaptive pattern-driven filters as set forth in claim 4, further comprising:
the object-program generated by the meta-program selected from the group consisting of: a codec, a modeler, and a combination of both.

6. A method for modeling data using adaptive pattern-driven filters as set forth in claim 1, further comprising:
the data is modeled to enable the data being compressed for purposes of reducing overall size of the data.

7. A method for modeling data using adaptive pattern-driven filters as set forth in claim 1, wherein the algorithm applied to the data further comprises:
providing a linear adaptive filter adapted to receive data and model the data that have a low to medium range of intensity dynamics;
providing a non-linear adaptive filter adapted to receive the data and model the data that have medium to high range of intensity dynamics; and
providing a lossless filter adapted to receive the data and model the data not modeled by the linear adaptive filter and the non-linear adaptive filter, including residual data from the linear and non-linear adaptive filters.

8. A method for modeling data as set forth in claim 7, wherein the linear adaptive filter further comprises:
tessellation of the data.

9. A method for modeling data as set forth in claim 8, wherein the tessellation of the data further comprises:
tessellation of the data as viewed from computational geometry.

10. A method for modeling data as set forth in claim 8, wherein the tessellation of the data is selected from the group consisting of planar tessellation and spatial (volumetric) tessellation.

11. A method for modeling data as set forth in claim 8, wherein the tessellation of the data is achieved by a methodology selected from the group consisting of:
a combination of regression techniques;
a combination of optimization methods including linear programming;
a combination of optimization methods including non-linear programming; and
a combination of interpolation methods.

12. A method for modeling data as set forth in claim 10, wherein the planar tessellation of the data comprises triangular tessellation.

13. A method for modeling data as set forth in claim 10, wherein the spatial tessellation of the data comprises tessellation selected from the group consisting of tetrahedral tessellation and tessellation of a 3-dimensional geometrical shape.

14. A method for modeling data as set forth in claim 8, wherein the tessellation of the data is executed by an approach selected from the group consisting of breadth-first, depth-first, best-first, any combination of these, and any method of tessellation that approximates the data subject to an error tolerance.

15. A method for modeling data as set forth in claim 12, wherein the tessellation of the data is selected from the group consisting of Peano-Cezaro decomposition, Sierpiski decomposition, Ternary triangular decomposition, Hex-nary triangular decomposition, any other triangular decomposition, and any other geometrical shape decomposition.

16. A method for modeling data as set forth in claim 7, wherein the non-linear adaptive filter further comprises:
a filter modeling non-planar parts of the data using primitive data patterns.

17. A method for modeling data as set forth in claim 16, further comprising:
the modeling of the non-planar parts of the data performed using a methodology selected from the group consisting of:
artificial intelligence;
machine learning;
knowledge discovery;
mining;
and pattern recognition.

18. A method for modeling data as set forth in claim 16, further comprising:
training the non-linear adaptive filter at a time selected from the group consisting of:
prior to run-time application of the non-linear adaptive filter; and
at run-time application of the non-linear adaptive filter, the non-linear adaptive filter becoming evolutionary and self-improving.

19. A method for modeling data as set forth in claim 16, wherein the non-linear adaptive filter further comprises:
a hash-function data-structure based on prioritization of tessellations, the prioritization based on available information within and surrounding a tessellation with the prioritization of the tessellation for processing being higher according to higher availability of the available information.

20. A method for modeling data as set forth in claim 16, wherein the non-linear adaptive filter further comprises:
a hierarchy of learning units based on primitive data patterns; and
the learning units integrating clusters selected from the group consisting of:
neural networks;
mixtures of Gaussians;
support vector machines;
Kernel functions;
genetic programs;
decision trees;
hidden Markov models;
independent component analysis;
principle component analysis; and
other learning regimes.

21. A method for modeling data as set forth in claim 20, wherein the hierarchy of learning units provide machine intelligence.

22. A method for modeling data as set forth in claim 20, wherein the primitive data patterns include a specific class of data.

23. A method for modeling data as set forth in claim 22, wherein the specific class of data is selected from the group consisting of:
2-dimensional data;
3-dimensional data; and
N-dimensional data where N is greater than 3.

24. A method for modeling data as set forth in claim 16, further comprising:
providing a set of tiles approximating the data;
providing a queue of the set of tiles for input to the non-linear adaptive filter;
the non-linear adaptive filter processing each tile in the queue;
for each tile selected, the non-linear adaptive filter determining if the selected tile is within a tolerance of error;
for each selected tile within the tolerance of error, the tile is returned as a terminal tile;
for each selected tile outside the tolerance of error, the selected tile is decomposed into smaller subtiles which are returned to the queue for further processing.

25. A method for compressing data, comprising:
providing a linear adaptive filter adapted to receive data and compress the data that have low to medium energy dynamic range;
providing a non-linear adaptive filter adapted to receive the data and compress the data that have medium to high energy dynamic range; and
providing a lossless filter adapted to receive the data and compress the data not compressed by the linear adaptive filter and the non-linear adaptive filter; whereby
data is being compressed for purposes of reducing its overall size.

26. A method for compressing data as set forth in claim 25, wherein the linear adaptive filter further comprises:
tessellation of the data.

27. A method for compressing data as set forth in claim 26, wherein the tessellation of the data is selected from the group consisting of planar tessellation and spatial tessellation.

28. A method for compressing data as set forth in claim 27, wherein the planar tessellation of the data comprises triangular tessellation.

29. A method for compressing data as set forth in claim 27, wherein the spatial tessellation of the data comprises tetrahedral tessellation.

30. A method for compressing data as set forth in claim 26, wherein the tessellation of the data is selected from the group consisting of breadth-first, depth-first, best-first, any combination of these, and any method of tessellation that approximates the data filtered by the linear adaptive filter within selectably acceptable limits of error.

31. A method for compressing data as set forth in claim 28, wherein the tessellation of the data is selected from the group consisting of Peano-Cezaro decomposition, Sierpiski decomposition, Ternary triangular decomposition, Hex-nary triangular decomposition, any other triangular decomposition, and any other geometrical shape decomposition.

32. A method for compressing data as set forth in claim 25, wherein the non-linear adaptive filter further comprises:
a filter modeling non-planar parts of the data using primitive image patterns.

33. A method for compressing data as set forth in claim 32, wherein the non-linear adaptive filter further comprises:
a hash-function data-structure based on prioritization of tessellations, the prioritization based on available information within and surrounding a tessellation with the prioritization of the tessellation for processing being higher according to higher availability of the available information.

34. A method for compressing data as set forth in claim 32, wherein the non-linear adaptive filter further comprises:
a hierarchy of learning units based on primitive data patterns; and
the learning units integrating clusters selected from the group consisting of:
neural networks;
mixtures of Gaussians;
support vector machines;
Kernel functions;
genetic programs;
decision trees;
hidden Markov models;
independent component analysis;
principle component analysis; and
other learning regimes.

35. A method for compressing data as set forth in claim 34, wherein the primitive data patterns include a specific class of images.

36. A method for compressing data as set forth in claim 32, further comprising:
providing a set of tiles approximating the data;
providing a queue of the set of tiles for input to the non-linear adaptive filter;
the non-linear adaptive filter processing each tile in the queue;
for each tile selected, the non-linear adaptive filter determining if the selected tile is within a tolerance of error;
for each selected tile within the tolerance of error, the tile is returned as a terminal tile;
for each selected tile outside the tolerance of error, the selected tile is decomposed into smaller subtiles which are returned to the queue for further processing.

37. A method for modeling an image for compression, comprising:
obtaining an image;
performing computational geometry to the image; and
applying machine learning to decompose the image; whereby
the image is represented in a data form having a reduced size.

38. A method for modeling an image for compression as set forth in claim 37, further comprising:
recomposing the image from the data form representation by machine learning.

39. A method for modeling an image for compression as set forth in claim 38, further comprising:
the image selected from the group consisting of:
a video image; and
a series of video images.

40. A method for modeling an image for compression, comprising:
formulating a data structure by using a methodology selected from the group consisting of:
computational geometry;
artificial intelligence;
machine learning;
data mining; and
pattern recognition techniques; and
creating a decomposition tree based on the data structure.

41. A method for modeling an image for compression as set forth in claim 40, wherein creating the decomposition tree is achieved by application of an approach selected from the group consisting of:
Peano-Cezaro decomposition;
Sierpiski decomposition;
Ternary triangular decomposition;
Hex-nary triangular decomposition;
any other triangular decomposition approach; and
any other geometrical shape decomposition method.

42. A method for modeling an image for compression as set forth in claim 41, wherein an image to be modeled is selected from the group consisting of:
a video image; and
a series of video images.

43. A method for modeling data using adaptive pattern-driven filters, comprising:
applying an algorithm to data to be modeled based on an approach selected from the group consisting of: computational geometry; artificial intelligence; machine learning; and data mining;
the data to be modeled selected from the group consisting of: 2-dimensional still images; 2-dimensional still objects; 2-dimensional time-based objects; 2-dimensional video; 2-dimensional image recognition; 2-dimensional video recognition; 2-dimensional image understanding; 2-dimensional video understanding; 2-dimensional image mining; 2-dimensional video mining; 3-dimensional still images; 3-dimensional still objects; 3-dimensional video; 3-dimensional time-based objects; 3-dimensional object recognition; 3-dimensional image recognition; 3-dimensional video recognition; 3-dimensional object understanding; 3-dimensional object mining; 3-dimensional video mining; N-dimensional objects where N is greater than 3; N-dimensional time-based objects; sound patterns; voice patterns; generic data of generic nature wherein no specific characteristics of the generic data are know to exist within different parts of the data; and class-based data of class-based nature wherein specific characteristics are known to exist within different parts of the class-based data, the specific characteristics enabling advantage to be taken in modeling the class-based data;
an overarching modeling meta-program generating an object-program for the data;
the object-program generated by the meta-program selected from the group consisting of: a codec, a modeler, and a combination of both;
the data is modeled to enable the data being compressed for purposes of reducing overall size of the data;
the algorithm applied to the data including providing a linear adaptive filter adapted to receive data and model the data that have a low to medium range of intensity dynamics, providing a non-linear adaptive filter adapted to receive the data and model the data that have medium to high range of intensity dynamics, and providing a lossless filter adapted to receive the data and model the data not modeled by the linear adaptive filter and the non-linear adaptive filter, including residual data from the linear and non-linear adaptive filters;
linear adaptive filter including tessellation of the data including tessellation of the data as viewed from computational geometry, the tessellation of the data selected from the group consisting of planar tessellation and spatial (volumetric) tessellation;
the planar tessellation including triangular tessellation;
the spatial tessellation of the data comprises tessellation selected from the group consisting of tetrahedral tessellation and tessellation of a 3-dimensional geometrical shape;
the tessellation of the data achieved by a methodology selected from the group consisting of: a combination of regression techniques; a combination of optimization methods including linear programming; a combination of optimization methods including non-linear programming; a combination of interpolation methods;
the tessellation of the data executed by an approach selected from the group consisting of breadth-first, depth-first, best-first, any combination of these, and any method of tessellation that approximates the data subject to an error tolerance;
the tessellation of the data is selected from the group consisting of Peano-Cezaro decomposition, Sierpiski decomposition, Ternary triangular decomposition, Hex-nary triangular decomposition, any other triangular decomposition, and any other geometrical shape decomposition;
the non-linear adaptive filter including a filter modeling non-planar parts of the data using primitive data patterns including a specific class of data selected from the group consisting of: 2-dimensional data; 3-dimensional data; N-dimensional data where N is greater than 3;
the non-linear adaptive filter including a hash-function data-structure based on prioritization of tessellations, the prioritization based on available information within and surrounding a tessellation with the prioritization of the tessellation for processing being higher according to higher availability of the available information, and including a hierarchy of learning units based on primitive data patterns, the hierarchy of learning units providing machine intelligence, the learning units integrating clusters selected from the group consisting of: neural networks; mixtures of Gaussians; support vector machines; Kernel functions; genetic programs; decision trees; hidden Markov models; independent component analysis; principle component analysis; other learning regimes;
the modeling of the non-planar parts of the data performed using a methodology selected from the group consisting of: artificial intelligence; machine learning; knowledge discovery; mining; and pattern recognition;
training the non-linear adaptive filter at a time selected from the group consisting of: prior to run-time application of the non-linear adaptive filter; at run-time application of the non-linear adaptive filter, the non-linear adaptive filter becoming evolutionary and self-improving;
providing a set of tiles approximating the data;
providing a queue of the set of tiles for input to the non-linear adaptive filter;
the non-linear adaptive filter processing each tile in the queue;
for each tile selected, the non-linear adaptive filter determining if the selected tile is within a tolerance of error;
for each selected tile within the tolerance of error, the tile is returned as a terminal tile; and
for each selected tile outside the tolerance of error, the selected tile is decomposed into smaller subtiles which are returned to the queue for further processing; whereby
the data is modeled to enable better manipulation of the data.

44. A method for compressing data, comprising:
providing a linear adaptive filter adapted to receive data and compress the data that have low to medium energy dynamic range, the linear adaptive filter including tessellation of the data;
the tessellation of the data selected from the group consisting of planar tessellation and spatial tessellation, wherein the planar tessellation of the data comprises triangular tessellation and wherein the spatial tessellation of the data comprises tetrahedral tessellation;
the tessellation of the data selected from the group consisting of breadth-first, depth-first, best-first, any combination of these, and any method of tessellation that approximates the data filtered by the linear adaptive filter within selectably acceptable limits of error;
the tessellation of the data selected from the group consisting of Peano-Cezaro decomposition, Sierpiski decomposition, Ternary triangular decomposition, Hex-nary triangular decomposition, any other triangular decomposition, and any other geometrical shape decomposition;
providing a non-linear adaptive filter adapted to receive the data and compress the data that have medium to high energy dynamic range;
the non-linear adaptive filter including a filter modeling non-planar parts of the data using primitive image patterns, the primitive image patterns including a specific class of images;
the non-linear adaptive filter including a hash-function data-structure based on prioritization of tessellations, the prioritization based on available information within and surrounding a tessellation with the prioritization of the tessellation for processing being higher according to higher availability of the available information;
the non-linear adaptive filter including a hierarchy of learning units based on primitive data patterns, the learning units integrating clusters selected from the group consisting of: neural networks; mixtures of Gaussians; support vector machines; Kernel functions; genetic programs; decision trees; hidden Markov models; independent component analysis; principle component analysis; other learning regimes;
providing a lossless filter adapted to receive the data and compress the data not compressed by the linear adaptive filter and the non-linear adaptive filter;
providing a set of tiles approximating the data;
providing a queue of the set of tiles for input to the non-linear adaptive filter;
the non-linear adaptive filter processing each tile in the queue;
for each tile selected, the non-linear adaptive filter determining if the selected tile is within a tolerance of error;
for each selected tile within the tolerance of error, the tile is returned as a terminal tile;
for each selected tile outside the tolerance of error, the selected tile is decomposed into smaller subtiles which are returned to the queue for further processing; whereby
such that data is being compressed for purposes of reducing its overall size.

45. A method for modeling an image for compression, comprising:
obtaining an image;
performing computational geometry to the image;
applying machine learning to decompose the image such that the image is represented in a data form having a reduced size; and
recomposing the image from the data form representation by machine learning; wherein
the image selected from the group consisting of: a video image and a series of video images.

46. A method for modeling an image for compression, comprising:
formulating a data structure by using a methodology selected from the group consisting of: computational geometry, artificial intelligence, machine learning, data mining, pattern recognition techniques; and
creating a decomposition tree based on the data structure, the decomposition tree is achieved by application of an approach selected from the group consisting of: Peano-Cezaro decomposition, Sierpiski decomposition, Ternary triangular decomposition, Hex-nary triangular decomposition, any other triangular decomposition approach, any other geometrical shape decomposition method; wherein
an image to be modeled is selected from the group consisting of a video image and a series of video images.

47. A data structure for use in conjunction with file compression, comprising:
binary tree bits;
an energy row;
a heuristic row; and
a residual energy entry.
